(19) United States
(12) Patent Application Publication
(10) Pub. No.: US 2013/0197810 A1
(43) Pub. Date: Aug. 1, 2013

(54) MONITORING OF DRINKING WATER AQUIFERS DURING POSSIBLE CONTAMINATION OPERATIONS

(71) Applicants: Allan Kayser Haas, Erie, CO (US); Andre Revil, Golden, CO (US)

(72) Inventors: Allan Kayser Haas, Erie, CO (US); Andre Revil, Golden, CO (US)

(21) Appl. No.: 13/751,978

(22) Filed: Jan. 28, 2013

Related U.S. Application Data
(60) Provisional application No. 61/591,760, filed on Jan. 27, 2012.

(51) Int. Cl. G01V 9/00; G01V 3/08; G06F 17/00; G01V 9/02

(52) U.S. Cl. CPC G01V 9/00; G01V 9/02; G01V 3/08; G06F 17/00
USPC 702/12; 702/6; 702/11; 324/345; 73/152.54; 73/152.51; 324/347

(57) ABSTRACT

A method and system for monitoring the integrity of a water aquifer is provided. The method and system generally monitors an aquifer for subsurface fractures, fluid intrusion, or water contamination. In one embodiment, the method and system may be utilized before, during, and after contaminating operations to monitor a water aquifer and generate reports detailing the effect of the contaminating operations on the water aquifer. The reports, and associated raw data, may be used as legal documents. For example, in one embodiment, an independent company is responsible for monitoring the aquifer and generating reports, which are then submitted to all interested parties, including the state for regulatory purposes.

### CROSS REFERENCE TO RELATED APPLICATION

This application claims priority under 35 U.S.C. §119(e) to U.S. Provisional Patent Application Ser. No. 61/591,760 filed Jan. 27, 2012, which is incorporated herein in its entirety by reference.

### FIELD

The present invention relates generally to monitoring the integrity of underground reservoirs, and more particularly to monitoring fluid aquifers during possible fluid contamination procedures, including for example, monitoring of water aquifers during all oil and gas extraction processes, including hydraulic fracturing, and other well completion operations. The present invention may also be used to determine if abandoned wells are leaking.

### BACKGROUND

General distrust of the oil and gas industry has spawned numerous environmentally conscience groups that oppose oil and gas operations for a variety of environmental concerns. One of these concerns is the contamination of drinking water aquifers caused by hydraulic fracturing operations. By extension, aquifer contamination may also occur after well installation and completion operations over time due to improperly installed aquifer protection zones during well construction. Also, well aging, and improper abandonment processes increase the potential for drinking water aquifer contamination. Additionally, there is no way to decisively determine whether the cementation operation for zonal isolation of aquifers has leak-proof integrity over the entire life span of a well. The lifespan of a well starts with well construction, through operations, and abandonment. Once a well is established, its existence in the environment is permanent; the pre-well conditions cannot be reversed through any known means. Therefore, the abandonment phase of a well is the longest period for any well of any type, and merits some careful attention.

Current methods of leak detection in wells employ cement bond logs, sustained annulus pressure monitoring, zonal pack-off and pressure testing, radioactive tracers, neutron activation, temperature gradients, passive acoustics, passive ultrasonic, and borehole video camera methods. For new well construction, these methods may be easily used. However, once a well has entered into production, the use of most of these methods requires taking the well out of service, removing the production equipment from the well before the leak detection and well integrity surveillance may proceed. Upon completion of the well integrity surveillance, the well may be returned to production status. During all of this activity, there is risk that something could go wrong, keeping the well off line for a much longer period of time than planned. This translates to lost revenue for the operator. For plugged and abandoned wells, there is no method to detect leaks without reestablishing connection to the well, thereby allowing wireline based leak detection methods to be used. Reestablishing connection to a well may be necessary to plug leaks, but may not be needed if a well has good integrity. However, abandoned well integrity cannot be determined without intervention. Therefore, an external method of well integrity surveillance is needed to screen through the millions of abandoned wells to determine if the wells possibly have leaks, require more investigation, and possibly require intervention to correct.

Specifically, cement bond logs only provide indications of a possible location for a leak, but do not positively provide leakage proof. Sustained annulus pressure or changes in annulus pressure, may or may not be an indication of a leak, but importantly, this only provides a possibility for detection if a leak exists. No information regarding the leak location or affected volume information would be determined. Zonal isolation and pressure testing may find leaks of moderate size, but the affected volume cannot be determined, and it is not a real-time detection method.

Radioactive tracers and neutron activation methods can locate leaks, and provide some flow direction indication, but these methods may not be suitable for finding leaks near drinking water aquifers, and they cannot determine overall affected volume.

Temperature based methods can detect higher temperature, high pressure intrusions of fluids, and can detect the drop in temperature due to gas expansion. Temperature methods are not likely to indicate affected volume, and can be somewhat ambiguous in the interpretation of where in the borehole the leak is located.

Acoustic methods (including ultrasonic) can locate leaks from the sounds they make, and as a result may be able to locate leak sources, possibly some annulus pathway information can be discovered, but they are not capable of determining the affected volume.

None of these leak detection techniques, other than casing pressure, are monitoring methods, and as such are not capable of monitoring the well for undesirable outside the casing fluid movement during normal well operations. If a leak develops in a well that is not under observation of any form, then there is no way to assess the well, leaving room for significant damage to subsurface drinking water resources to occur before a leak is detected. A knowledge gap about well integrity, over the lifetime of wells of all types, becomes evident when faced with the large number of wells that are in various stages of use. This knowledge gap leaves room for a technical solution to well integrity related problems associated with leaks that result in undesirable outside the casing fluid movement. Thus, there is currently no external to the borehole real-time method to detect and localize leaking oil and gas wells.

In the case of hydraulic fracture operations, a method commonly utilized to enhance the permeability of subterranean geological formations, possible damage to aquifers may occur if the process is not executed properly. For example, hydraulic fracture operations are commonly employed by oil and gas companies to fracture subterranean formations, thereby providing a passage for fluid and/or gas hydrocarbons to flow to a wellbore. In addition, hydraulic fracture operations may be employed by the geothermal industry to provide an improved fluid passage for thermal exchange. However, despite the beneficial uses of hydraulic fracture operations, the operations are controversial because of potential contamination concerns. For example, allegations have been made that hydraulic fracture operations contaminate drinking water aquifers. There is also the concern that an improperly executed hydraulic fracturing operation in relative close proximity to an existing well may damage the existing well and cause undesirable leakage of fluids and gases. Unfortunately, this has occurred at least once in North America, specifically in Alberta Canada (Oil & Gas Journal editors, 2012). External monitoring of the existing well may have provided additional knowledge of how this event occurred.

Particular attention should be focused on abandoned wells, because long term well integrity cannot be guaranteed for a large number of these types of wells, especially for wells that have been constructed with old well construction practices. Generally, well abandonment begins when a well is taken out of service permanently. It is plugged, and enters the abandoned phase of its life. At the time of abandonment, the well is usually considered to have good integrity, and is no longer monitored for integrity during the remaining period of the well's existence. The abandonment phase lasts essentially forever, and it is the time period where many unmonitored physical changes to a well can occur as it ages, resulting in increased risk of well integrity break down and leakage. The extent of the problem is currently unknown. Currently, there is no method to resolve the uncertainty associated with abandoned wells. The present invention proposes a solution to the complex problem of the well integrity of abandoned wells. The central problem with leaking oil and gas wells concerns the well annulus cement associated with the isolation of protected zones. Poor or improperly positioned cement may lead to leakages into protected zones. This leakage may occur through inconsistent cement formulations, poorly cleaned drilling mud from borehole walls, and improper cement formulations. Additionally, old cement may shrink away from the borehole wall, causing poor sealing to the formation. The shrinkage of annulus cement may cause micro-annulus voids, allowing pathways for fluids and gasses to enter protected formations, such as drinking water aquifers. These problems may occur at any age of a well, and as wells age, the problem may worsen. Currently, there is no way to absolutely determine if leakage is present, nor where the leakage is occurring.

Proponents of the hydraulic fracture operations vigorously deny the contamination allegations. Currently however, there is no real-time method to validate claims either way. Additionally, distrust of the hydraulic fracture operations continues to increase even though there is no direct evidence of contamination pathways. Existing technology is not capable of capturing adequate data to resolve this dispute. Thus, there is a need for a method and system capable of monitoring an aquifer, identifying aquifer contamination, and capturing data indicating the source of the contamination. The following patents and patent publications are related to monitoring hydraulic fracture operations: U.S. Pat. No. 4,567,945; U.S. Pat. No. 5,514,963; U.S. Pat. No. 6,978,672; U.S. Pat. No. 7,243,718; U.S. Pat. No. 7,819,181; U.S. Pat. No. 7,891,417; U.S. Patent Publication No. 2005/0017723; U.S. Patent Publication No. 2009/0166030; and U.S. Patent Publication No. 2009/0256575; the entirety of each disclosure is hereby incorporated herein by reference.

In general, the real-time detection and localization of well leakages of any cause at any well age is not available to the oil and gas industry. Also, there is no existing method that will determine the extents of a leak if one is found. In other words, if a leak has contaminated an aquifer, there is no method to reliably determine the amount of damage that has been done. The present invention solves these and other problems.

### SUMMARY

The present disclosure is generally directed to a method and system that monitors an aquifer, identifies aquifer contamination, and captures data indicating the source and extent of the contamination. The method and system described herein may be applied to all types of wells regardless of the well's purpose, including for example, pumping and injection wells for all purposes, such as drinking water wells, carbon sequestration injection, produced waters reinjection, waste fluid injection well for disposal, environmental contamination treatment wells, oil wells, and/or gas wells. In one embodiment, the method and system detects fluid movements in an aquifer, in the vicinity of any well installation, reservoir, and/or hydraulic fracturing operation, determines the location of the fluid movements, and determines if the movements are related to the well or reservoir under observation.

It is one aspect of the present disclosure to provide a method of monitoring a drinking water aquifer for contamination. In one embodiment, sensors acquire aquifer data before, during, and after a potentially contaminating operation. For example, the data may be used to evaluate whether a hydraulic fracturing operation caused an undesirable disturbance to an aquifer. An undesirable disturbance may include the release of gas, oil, and/or fracture fluid into the aquifer, and/or damage to existing subsurface infrastructure within an aquifer that may release fluids and/or gases into the aquifer. Additionally, data acquired during hydraulic fracture operations may be compared to pre-operations data to identify changes in the aquifer. The acquired data also may be time correlated with the stages of a hydraulic fracturing operation to determine if there is a link between the operation and any detected change in the aquifer. In general, data acquired after the completion of any potentially contaminating operation may be compared to pre-operation data to identify any permanent changes to an aquifer. In some embodiments, multiple aquifers may be monitored before, during, and after a potentially contaminating operation. The selection of aquifers to be monitored may depend upon the proximity of the aquifer to the potentially contaminating operation, the size of the aquifer, and the criticality of the aquifer in meeting drinking water needs, present and/or future.

The present invention may also be used to detect leaks near the surface of any well or deeper in the subsurface of any well, including abandoned wells, injector wells, water wells, waste storage, or carbon sequestration wells.

It is another aspect of the present disclosure to provide a system for monitoring a drinking water aquifer for contamination. In one embodiment, a combination of sensors acquires data from an aquifer. The combination of sensors may include, but is not limited to, a pressure sensor, a temperature sensor, a chemical sensor, a vector magnetometer, an electric potential sensor employing a non-polarizing electrode or a metallic electrode, and an electrode array comprising of non-polarizing or metallic electrodes or any combination of non-polarizing and metallic electrodes and/or any other combination of sensors. An electrode array may be used to measure the electric potential and resistivity between the individual electrodes of the array. Resistivity measurements include the application of DC resistivity, complex resistivity, spectral induced polarization, and induced polarization methods. The acquired data may be analyzed in real-time and/or stored for post-acquisition analysis. Reports may be generated based upon the data.

It is another aspect of the present invention to provide a method for the correction of long term drift in the electrical potential data, which may be due to electrical telluric currents. Telluric currents may be introduced into the conductive subsurface porous media due to electrical ionic current fluctuations in the earth's ionosphere. These telluric currents generate voltages in the conductive subsurface media, and these telluric based voltages are superimposed on any other voltages that may be caused by fluid movements within the monitored subsurface volume. The telluric induced voltages may interfere with the detection and localization of leakage generated voltages, and therefore must be compensated for during long term aquifer monitoring. This form of compensation improves the sensitivity of the monitoring system to slow leakage flow of fluids and gases.

It is another aspect of the invention to provide a system for the correction of long term drift in the electrical potential data. This system embodiment, employing telluric effects compensation, comprises surface mounted three axis magnetic field measurement sensors, three axis electric field measurement sensors, signal receivers for the sensors, and a data processing system. The data processing system may determine the induced subsurface telluric currents and resulting voltages in combination with subsurface resistivity tomography data.

It is another aspect of the present invention to provide a method for the correction of long term drift in the electrical potential data, which may be due to electronics and non-polarizing electrode temperature changes. All electrical components, including non-polarizing electrodes, have temperature coefficients. In this aspect of the invention, temperature compensation methods may be used within the electronics to improve system monitoring sensitivity to small changes in voltages caused by fluid movement in the subsurface. Another aspect of the invention is a system for correlating long term drift in the electrical potential data. Non-polarizing electrodes with low temperature coefficients may be used. To maximize the sensitivity of the system to the signals of interest, temperature sensors may be used within the non-polarizing electrodes to facilitate temperature correction of the measured signals.

The phrases “at least one”, “one or more”, and “and/or”, as used herein, are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity, as used herein, refers to one or more of that entity. As such, the terms “a” (or “an”), “one or more” and “at least one” may be used interchangeably herein.

The use of “including,” “comprising,” or “having” and variations thereof herein is meant to encompass the items listed thereafter and equivalents thereof as well as additional items. Accordingly, the terms “including,” “comprising,” or “having” and variations thereof may be used interchangeably herein.

The term “desktop”, as used herein, refers to a metaphor used to portray systems. A desktop typically includes pictures, called icons that show applications, windows, cabinets, files, folders, documents, and other graphical items. The icons are generally selectable through user interface interaction to allow a user to execute applications or conduct other operations.

The term “display”, as used herein, refers to a portion of a screen used to display the output of a computer to a user.

The term “module”, as used herein, refers to any known or later developed hardware, software, firmware, artificial intelligence, fuzzy logic, or combination of hardware and software that is capable of performing the functionality associated with that element.

The terms “determine”, “calculate” and “compute,” and variations thereof, as used herein, are used interchangeably and include any type of methodology, process, mathematical operation or technique.

It shall be understood that the term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the invention, brief description of the drawings, detailed description, abstract, and claims themselves.

The term “contaminating operation” or “potentially contaminating operation” include but are not limited to, oil and gas extraction operations, such as hydraulic fracturing, mining operation, oil and gas recovery, fluid or gas injection for any purpose, or the like where there is a possibility or a perceived possibility of contaminating a water source.

The Summary is neither intended nor should it be construed as being representative of the full extent and scope of the present disclosure. The present disclosure is set forth in various levels of detail in the Summary as well as in the attached drawings and the Detailed Description and no limitation as to the scope of the claimed subject matter is intended by either the inclusion or non-inclusion of elements, components, etc. in this Summary. Moreover, reference made herein to “the present invention” or aspects thereof should be understood to mean certain embodiments of the present disclosure and should not necessarily be construed as limiting all embodiments to a particular description.

### BRIEF DESCRIPTION OF THE DRAWINGS

The accompanying drawings, which are incorporated in and constitute a part of the specification, illustrate embodiments of the disclosure and together with the general description given above and the detailed description of the drawings given below, serve to explain the principles of these embodiments.

FIG. 1 is a block diagram of an aquifer monitoring system according to one embodiment of the present disclosure;

FIG. 2 illustrates the use of a non-polarizing electrode;

FIG. 3 illustrates a dipole configuration of a dipole electrode;

FIG. 4 illustrates a telluric measurement device;

FIG. 5 illustrates a single electrode node;

FIG. 6 illustrates a dual electrode node;

FIG. 7 illustrates an analog dual sensor;

FIG. 8 illustrates a digital dual sensor;

FIG. 9 illustrates a multi-sensor node;

FIG. 10 illustrates a well monitoring system;

FIG. 11 illustrates a real-time data processing system for multi-processors;

FIG. 12 is an example communications/data processing network system that may be used in conjunction with embodiments of the present disclosure;

FIG. 13 is an example computer system that may be used in conjunction with embodiments of the present disclosure;

FIG. 14 is a block diagram of an aquifer monitoring method according to one embodiment of the present disclosure.

FIG. 15 illustrates an experimental configuration;

FIG. 16 illustrates a flow chart for processing electrical potential data;

FIG. 17 illustrates self-potential time series related to hole 9 saline water injections;

FIG. 18 illustrates self-potential spatial voltage distributions for snapshot E0 and E1;

FIG. 19 illustrates self-potential spatial voltage distributions for snapshot E2 and E3;

FIG. 20 illustrates fluid pressure, acoustic emissions and electrical potential changes during a given time period;

FIG. 21 illustrates key details of the model construction;

FIG. 22 illustrates the streaming current in the porous volume; and

FIG. 23 illustrates the steady state solutions of a model.

It should be understood that the drawings are not necessarily to scale. In certain instances, details that are not necessary for an understanding of the disclosure or that render other details difficult to perceive may have been omitted. It should be understood, of course, that the claimed subject matter is not necessarily limited to the particular embodiments illustrated herein.

To assist in the understanding of the drawings, the following is a list of components and associated numbering found in the drawings:

### DETAILED DESCRIPTION

The present invention relates to a real-time leak detection method and system for the detection of a leak, either short term or long term leaks, into an aquifer or other protected location connected to or in the proximity of a well or multiple wells used for any purpose. The method monitors the streaming potential, based on fluid movement in aquifers or other protected fluid containing formations in the subsurface. If the real-time leak detection method is used at the onset of the life of a well or wells, a baseline measurement may be taken prior to processes being employed that may cause contamination within a protected formation. The baseline may then be used to determine the baseline fluid movement in the protected formation and may be compared to the fluid movement once a potentially contaminating process is introduced into the system. The voltage gradient is one measurement that may be monitored in order to determine if a leak exists in a system. The voltage gradient may be based on fluid movement, or displacement of water in an aquifer or other protected formation. Displacement of the fluid may be caused by gas, or another fluid, or combinations thereof.

Different factors may cause leaks within the monitored well. For example, there may be cracking or micro annulus in the inside (around a concrete or other form of porous media plug) and/or outside casing, in the cement annulus of a well or between the cement in a well annulus and the formation being sealed or protected, or casing joint leaks. The cement may fail due to poor cement composition or stress or strain on the cement. The cement itself may be porous allowing for leaks within the system. Other sources may also cause leaks within the monitored well.

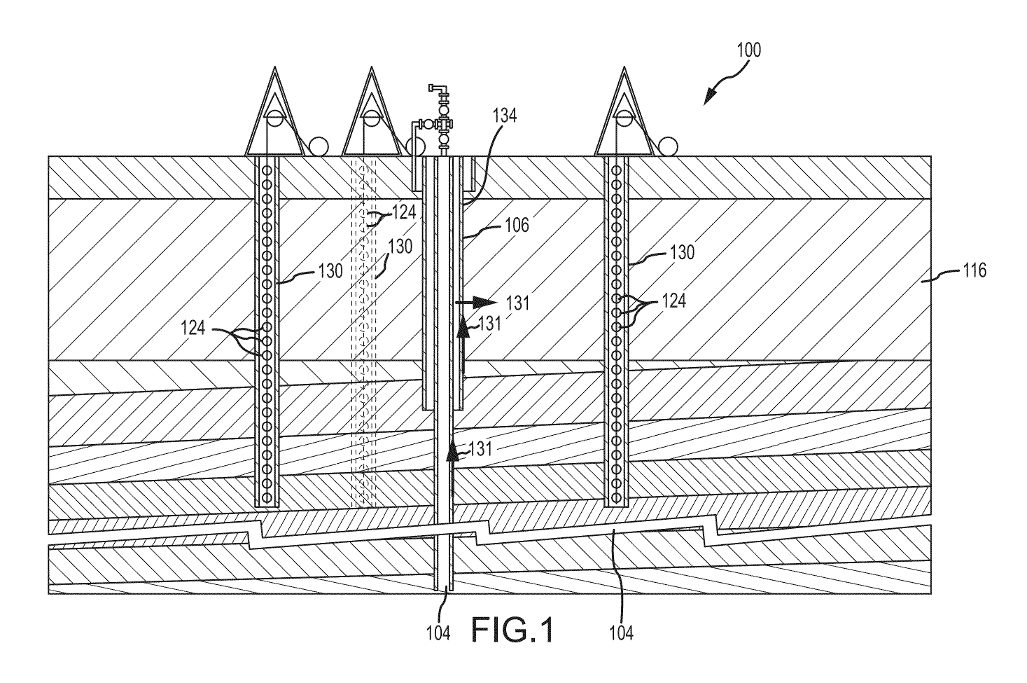

With reference to FIG. 1, a system for monitoring an aquifer according to one embodiment of the present disclosure is provided. FIG. 1 illustrates an aquifer monitoring system 100 around a monitored well with a leak. The system 100 comprises a contaminating fluid 104, a monitored wellbore 106 for transporting the contaminating fluid 104 to the surface, one or more monitoring wells 130, a plurality of sensors 124, an annulus 134 and an aquifer 116. Leaks 131 illustrates possible leaks within the monitored well caused by one or more sources, such as poor joints in the casing, poor cementation in the annulus, porous cement in the annulus or a number of other causes. One or more, in many cases at least one, monitoring wells 130 are positioned near a monitored well 106. The monitoring wells 130 may be positioned up to about 1000 meters from the monitored well 106. The monitoring wells 130 may be positioned about 10 meters, about 15 meters, about 20 meters, about 25 meters, about 30 meters, about 35 meters, about 38 meters, about 40 meters, about 50 meters, about 60 meters, about 70 meters, about 80 meters, about 90 meters, about 100 meters, about 200 meters, about 250 meters, about 300 meters, about 350 meters, about 400 meters, about 450 meters, about 500 meters, about 550 meters, about 600 meters, about 650 meters, about 700 meters, about 750 meters, about 800 meters, about 850 meters, about 900 meters, about 950 meters, or about 1000 meters from the monitored well 106. The monitored wells 106 and/or the monitoring wells 130 may be up to about 2000 feet below the surface and the diameter of the monitored well 106 and/or the monitoring well 130 may vary and may be up to about 6 inches in diameter. The monitoring wells 130 may be about 200 meters, about 250 meters, about 300 meters, about 350 meters, about 500 meters, about 550 meters, about 575 meters, about 600 meters, about 700 meters, about 800 meters, about 900 meters, about 950 meters, about 1000 meters, about 1500 meters, about 1750 meters, about 1800 meters, about 1900 or about 2000 feet below the surface, or any value between about 0 feet to about 2000 feet. The diameter of the monitored well 106 may be about 4 inches, about 5 inches, or about 6 inches. The diameter of the monitoring well 130 may be about 2 inches, about 3 inches, about 4 inches, about 5 inches, or about 6 inches.

The plurality of sensors 124 may be a function of the estimated or modeled voltage distribution at the monitoring well(s) distance from the monitored well(s). The number of the plurality of sensors 124 may be determined by the sensitivity of the sensors to the voltage distribution caused by leaks. Thus, the position of the sensors 124 within the monitoring well 130 may be determined by the voltage distribution required to determine if a leak exists. As would be understood by one having skill in the art, the number and position of the sensors 124 may vary depending on a number of factors, such as the sensitivity of the sensors 124, and the range of the sensors 124 from the monitored well(s) for measurements, which will depend on protected formation electrical, and geological factors. In some embodiments, the sensors 124 may be placed in the monitoring well 130 between about 1 meter to about 20 meters from each other. The sensor placement may depend upon the type of sensors 124 used within the monitoring well 130. If multiple different types of sensors 124 are included, then the minimum spacing between the sensors 124 may be greater than about 1 meter. The sensor placement may also depend upon the distance between the monitoring well 130 and the monitored well 106, the subterranean formation thickness, the geology near the monitoring well, and the electrical, acoustic, and/or chemical characteristics near the monitoring well. The sensors 124 may be placed within the monitoring well 130 in any suitable fashion. In some embodiments, the sensors 124 may be a vertical array of sensors 124. In other embodiments, the sensors 124 are secured to a specific location within the monitoring well 130. Furthermore, there may be redundancy of the sensors 124 within the monitoring well 130.

Different types of sensors may be used within the monitoring well 130. Sensors 124 may be pressure sensors, temperature sensors, chemical sensors, electric potential sensors, and/or electrode arrays, vector magnetometers, acoustic, accelerometers, and/or geophone sensors, pH sensors or the like. Combinations of different types of sensors may also be used in any combination configured in one or more sensor arrays.

In one embodiment, the sensors 124 may be configured to detect disturbances originating from a variety of directions and distances. For example, the sensors 124 may be configured to detect disturbances originating within and/or beneath the aquifer 116. In one embodiment, pressure sensors and electrode arrays detect fluid movement in and around the aquifer 116 before, during, and after potentially contaminating operations. Further, in one embodiment, the sensors 124 are selectively positioned within or around the aquifer 116, and time synchronized with each other, to facilitate the detection and determination of the location of the source of a disturbance, which may be an impulse created by a potentially contaminating operation. In some embodiments, important facilities or facilities deemed to be at risk during a potentially contaminating operation, for example, in hydraulic fracturing other wells or other subsurface facilities, including the well being subjected to a potentially contaminating operation itself, may be monitored. A monitoring system, which may include an electric potential sensor and a pressure sensor, may be associated with the wellbore 106 to monitor the fracture operation. In these embodiments, the sensors 124 may be time synchronized with the monitoring system of the fracture operation. The number of sensors 124 utilized depends, for example, on the extent of the potentially contaminating operations, the existing local surface infrastructure, the local subsurface infrastructure, the aquifer-aquitard system, or plurality of aquifers and aquitards, and the existence of other wells near the potentially contaminating operations.

To position the sensors 124 around and/or within with aquifer 116, a series of relatively shallow, monitoring wells 130 are drilled. These monitoring wells 130 may be temporary or permanent, depending on whether monitoring will be temporary or permanent. In some embodiments, a plurality of monitoring wells 130 are drilled to insure adequate subsurface monitoring during each stage of the potentially contaminating process. To monitor critical aquifer-aquitard systems or other protected formations near the potentially contaminating operations, monitoring wells 130 may be constructed in a manner that facilitates monitoring of numerous aquifer-aquitard systems or other protected formations. Where subsurface infrastructure exists, such as existing wells (regardless of purpose, condition, depth, and age) or other subsurface facilities, more than one monitoring well in different positions around the infrastructure may be required to insure adequate subsurface facility coverage for monitoring purposes. In some embodiments, a plurality of sensors is positioned within each monitoring well 130 to insure adequate coverage of the aquifer 116 or other protected formations is achieved. Referring back to FIG. 1, the sensors 124 are in communication with a transceiver, which transmits the sensor data through a network.

Concerning abandoned wells, a particular potentially contaminating operation may not being actively operating, and therefore the monitoring system 100 may be used to passively detect the undesirable intrusion of fluids into aquifer-aquitard systems or other protected formations.

In some embodiments, the sensors 124 may include electrodes. The sensors 124 may be placed in a vertical array of the electrodes that extend below the aquifers 116 or other protected formations being monitored. More than one aquifer 116 or other protected formations may be monitored at one time. A plurality of sensors 124 may be placed below the protected formations being monitored and spaced accordingly to detect a spatial distribution of signals in any formations being monitored.

The monitoring well 130 may comprise a pipe for encasing the plurality of sensors 124. The pipe may be made of any suitable material. In some cases, the pipe material may be a plastic, a polymer, fiberglass, or other suitable nonconductive material. In some embodiments, the pipe is a PVC material. The pipe may have a plurality of holes in any suitable configuration. There should be enough holes in the monitoring well 130 pipe to allow the electrodes to process the electrical disturbances in the formation. The holes may extend through the full length of the monitoring well 130 pipe. Alternatively, the holes may not extend through the full length of the monitoring well 130 pipe. For example, if a monitoring well 130 extends into a zone where different aquifers must be separated from each other, then the holes may not extend through the full length of the monitoring well 130 pipe. A metal material must not be used for the pipe material of the monitoring well 130 because the metal material will shield the voltage sensors from the spatial distribution of the voltage caused by a leak, preventing the electrical detection of leaks.

Furthermore, casing of the monitored well 106, if made from a metallic material, may also cause a distortion in the spatial distribution of the voltage caused by a leak within the casing or in close proximity to the well, and should be accounted for when determining if a leak exists in the system 100. This accounting may be present in a computation. Alternatively, the casing potential may be forced to a reference potential with an electronic feedback and control circuit. This may cause the casing potential to be reduced or eliminated, depending on the voltage reference location chosen. The casing potential may also be used in a simplified leak detection system, and then be nulled to allow for leak range determination (below aquifer, or within aquifer).

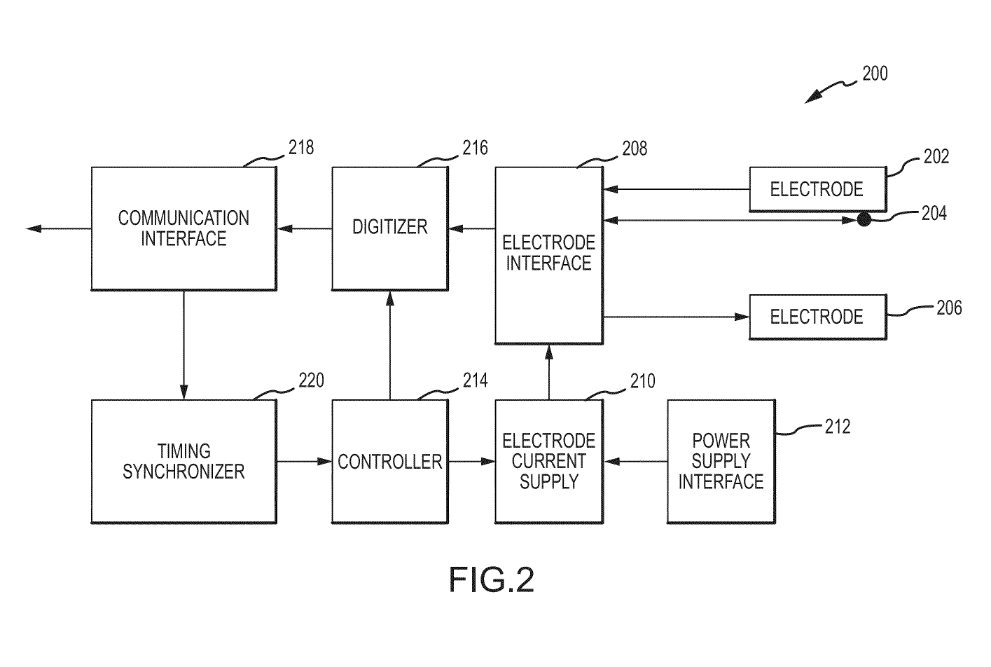

FIG. 2 illustrates another embodiment of a sensor node 200 of present invention. The embodiment in FIG. 2 illustrates the use of a non-polarizing electrode 202 and a polarizing electrode 206. A plurality of sensor node 200 may be used in the monitoring well of the present invention. Additionally, the sensor node 200 may be combined with other sensor node systems to comprise a sensor array within the monitoring well. The polarizing electrode 206 may be any suitable material, including stainless steel. The material chosen for the polarizing electrode 206 should not corrode because any corrosion in the subsurface may generate a voltage that could interfere with the voltage measurements. Other suitable materials include, but are not limited to, gold, and platinum. Though not illustrated, it is understood that a plurality of electrodes may be used with this embodiment. The non-polarizing electrode 202 may be used for voltage measurements. The polarizing electrode 206 may be used for sourcing current for a resistivity measurement. The sourcing current may include complex time domain waveforms including positive and/or negative current pulses with various pulse widths and repetitions (pulse widths in the range of about 0.001 s through about 10 s or more may be used) as well as sine waves of a variety of different frequencies (ranging from about 0.001 Hz through about 50 kHz). A temperature sensor 204 may also be used with the electrode 200. The temperature coefficient of the sensor node electrode 202 may be measured in a laboratory environment, or in the monitoring well while the system containing sensor node 200 is deployed. A correction to the voltage measurement from the sensor node electrode 202 may be numerically applied to the acquired voltage data. This corrected voltage measurement may be used to compensate data from the sensor node 200 for temperature changes and offset errors due to differences in electrode positions in the monitoring wells. The non-polarizing electrode 202 and the temperature sensor 204 may need a noise shield and electrode capacitance reduction by use of a driven shield, and a ground shield. Both the polarizing electrode 206, and non-polarizing electrode 202 bodies, and interconnect wires to the electrode interface 208 may be surrounded by the electrical shielding except for one location that acts as the electrode voltage detection surface. The non-polarizing electrode 202, the temperature sensor 204 and the polarizing electrode 206 may interface with an electrode interface 208. Other sensors may be used, including fiber-optic sensors for detecting electric fields, magnetic fields or both, for example. The electrode interface 208 may interface with a signal digitizer 216 and an electrode current supply 210. The electrode current supply may interface with the power supply interface 212 for supplying power to drive current through the polarizing electrode 206. The electrode current supply 210 may also interface with a controller 214. The controller 214 may be used to control the magnitude, polarity, and the timing of the current injected into the polarizing electrode 206 and surrounding formation as well as other sensor channel characteristics such as gain, sample rate, and bandwidth. Optionally, a timing synchronizer 220 may be used to direct the controller 214 to synchronize the current injection with the voltage measurements, and ensure synchronization of all of the sensor measurements within the entire sensor system at specific time intervals. It is important to ensure that all of the sensor signals are measured at the same time with minimal signal skew throughout the entire system. Signal skew is the time difference between individual sensor measurements that are supposed to be taken within the same time interval. The timing synchronizer may be used to minimize the difference between individual sensor measurements within the entire system. Synchronization of the sensor measurements is important for the temporal correlation of signals measured by the various sensors. Correlation of the signals is crucial for leak detection and localization. Significant timing skew in the sensor data may adversely impact leak detection and localization. The communication interface 218 may interface with the timing synchronizer 220, the controller 214 and/or the signal digitizer 216. The communication interface 218 also interfaces with the main cable interface, passes through the main cable to the sensor array surface electronics. The communications interface 218 may include, but is not limited to, one or more of various digital communications devices that implement RS422, RS485, LVDS (low voltage digital signaling), or other digital communications physical layer interfaces. The communication interface 218 may include fiber-optics, wireless or wired implementations. Additionally, the communications interface 218 with or without the controller 214 may also implement any one or more of a variety of digital communication protocols. The nature of the digital communications system requirements may depend on the digital communications speed requirements and the number of sensors within a given sensor system configuration.

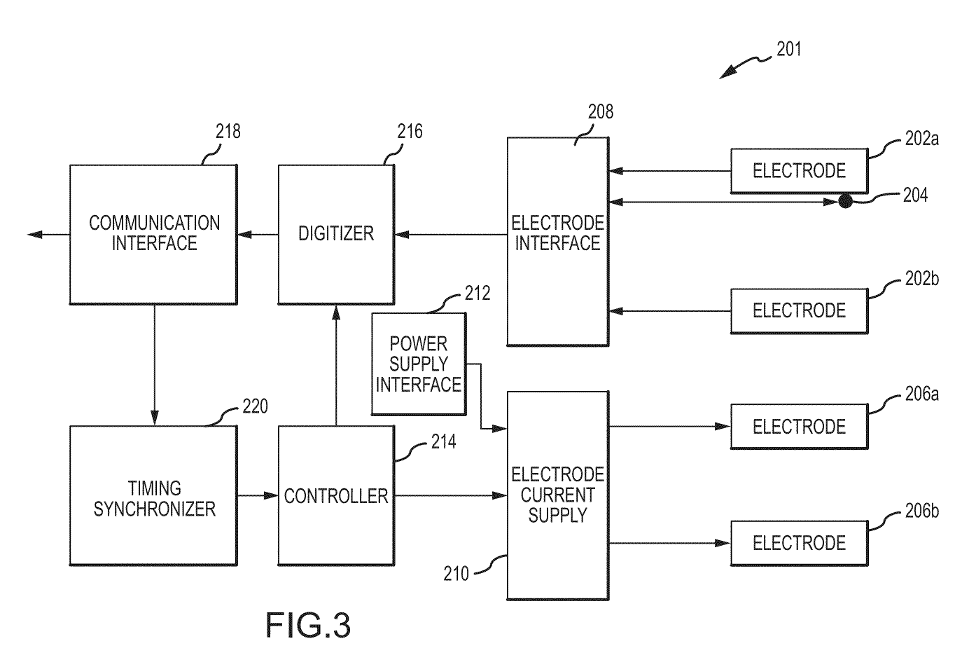

FIG. 3 illustrates a dipole configuration of a dipole sensor node 201. A plurality of sensor node 201 may be used in the monitoring well of the present invention. Additionally, the sensor node 201 may be combined with other node systems to comprise a sensor array within the monitoring well. The dipole sensor node 201 has similar components to sensor node 200 in FIG. 2. However, the electrodes in FIG. 2 are single electrodes, where the dipole sensor node 201 is in a dipole configuration. Similar to the single pole configuration of FIG. 2, the dipole sensor node 201 comprises a communications interface 218, a signal digitizer 216, an electrode interface 208, an electrode current supply 210, a power supply interface 212, a controller 214, a temperature sensor 204 and a timing synchronizer 220. The non-polarizing electrodes 202a and 202b are temperature compensated and monitored with a temperature sensor 204. The non-polarizing electrodes 202a and 202b are used to measure the electric field at the physical location of the dipole sensor node 201. The polarizing electrodes 206a and 206b are used to source current for resistivity measurements when the non-polarizing electrodes 202a and 202b are not used. In this configuration, electrical current is sourced into the formation with one electrode 206a or 206b and current is sunk or drained from the formation with the other electrode 206a or 206b, generating a dipolar electrical current source of a polarity that is determined by which electrodes are sourcing 206a or 206b or sinking 206a or 206b current and the electrode 206a and 206b separations.

When the non-polarizing electrodes 202a and 202b are used, the polarizing electrodes 206a and 206b may be electrically disconnected from the monitoring well and formation so that they do not source or sink current. In general, the polarizing electrodes 206a and 206b are not used for measurements. Rather, the polarizing electrodes 206a and 206b are only for supplying current during the times when they are needed. During resistivity measurements, the timing synchronizer 220 would switch specifically selected pairs of the polarizing electrodes 206a and 206b in a manner that would allow for the sourcing and sinking of current between them (one sources current, and the other sinks current) generating a dipole current source of one polarity or another. When a plurality of dipole nodes 201 are used, all other polarizing electrodes 206a and 206b in a dipole node 201 may remain disconnected, and all of the non-polarizable electrodes 202a and 202b (possibly except for the non-polarizing electrodes 202a and 202b at the current sourcing and sinking positions) may be enabled to measure the voltage distribution in the in the monitoring wellbore and surrounding formation.

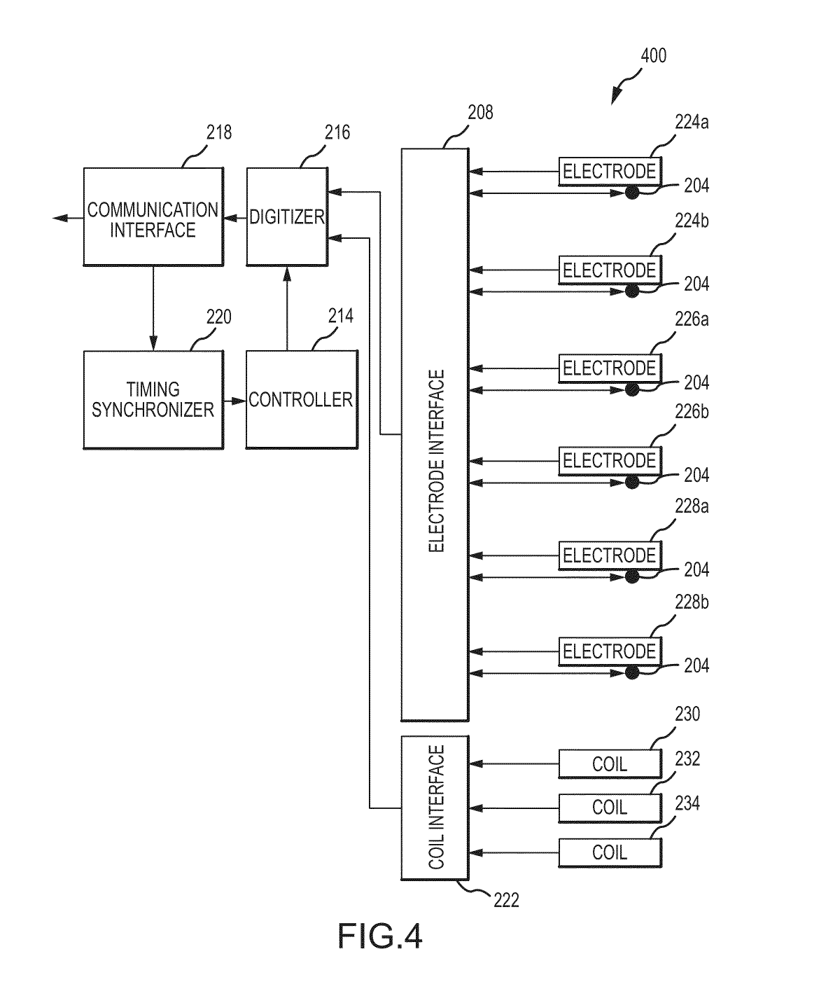

FIG. 4 illustrates a telluric measurement device 400 which is an embodiment of the details of the stationary magnetotelluric monitoring system 1026. The telluric measurement device measures the telluric effects. Telluric effects may have to be considered to determine the electric potential measurements with durations of more than a few hours. The telluric measurement device 400 may track the magnetic fields, and electric fields that are related to lightening events, solar, and ionosphereic disturbances that induce currents into the ground. These measurements and data resulting may be used to correct the electrical potential measurements made by the monitoring system. The effects of the telluric currents measured with the telluric measurement components of the embodiment, the resistivity of the region around the well, and computations of the resulting voltages due to the telluric currents through the resistive volume of the subsurface may be computed. These computed telluric voltages may be subtracted from the well monitoring voltage sensor data to produce a telluric effects corrected data set.

The telluric measurement device 400 comprises a communication interface 218, a signal digitizer 216, a timing synchronizer 220, a controller 214, a coil interface 222 and an electrode interface 208. The electrode interface 208 communicates with non-polarizing electrodes 224a, 224b, 226a, 226b, 228a, and 228b. The temperature sensors 204 monitor the temperature compensation in the non-polarizing electrodes 224a, 224b, 226a, 226b, 228a, and 228b. The telluric measurement device 400 detects the 3D configuration of the electric field and magnetic field variations due to ionosphere fluctuations. These fields have orthogonal components that may be detected with both electric field and magnetic field sensors, each sensor type may be oriented orthogonally to each other. In this case, the electrodes 224a and 224b comprise an electric field sensor for the x component of the electric field induced into the earth by the telluric currents. Two electrodes are required to measure the potential gradient (electric field). Likewise for the electrodes 226a, and 226b provide measurements for the y component and electrodes 228a and 228b provide measurements for the z component. These electrodes may be installed on the surface of the earth or in shallow boreholes to achieve the needed orthogonal arrangement to detect the induced 3D electric field in the earth. Another embodiment of the electric field sensors may use fewer than six electrodes to make the electric field measurement. At the coil interface 222, the coil 230 provides measurements in for x component of the magnetic field, coil 232 provides measurements for the y component of the magnetic field, and coil 234 provides measurements for the z component of the magnetic field of the earth, comprising an induction based vector magnetometer. The telluric measurement device 400 may also include fiber-optic sensors for detecting electric fields, magnetic fields or both. Other magnetic field sensor embodiments may employ different magnetic field sensor technologies instead of, or in addition to the induction based sensor coils 230, 232, and 234. These different magnetic field sensor technologies may include but are not limited to various vector magnetometer sensors employing magnetostrictive, hall effect, fluxgates, or other vector magnetometer implementations. This includes microelectromechanical systems (MEMS) based vector magnetometer components that employ various magnetic field detection methods. The communication interface 218 may include fiber-optics, wireless or wired implementations. The implementation of the data communications protocol used in telluric measurement device 400 may be the same as or similar to the data communication protocol used with sensor node 200 or dipole sensor node 201. The communication interface 218 may connect to the real-time data acquisition system, which may have a combination of analog and digital data acquisition embodiments. It is possible that a commercially available stationary magnetotelluric monitoring system may be employed for this function.

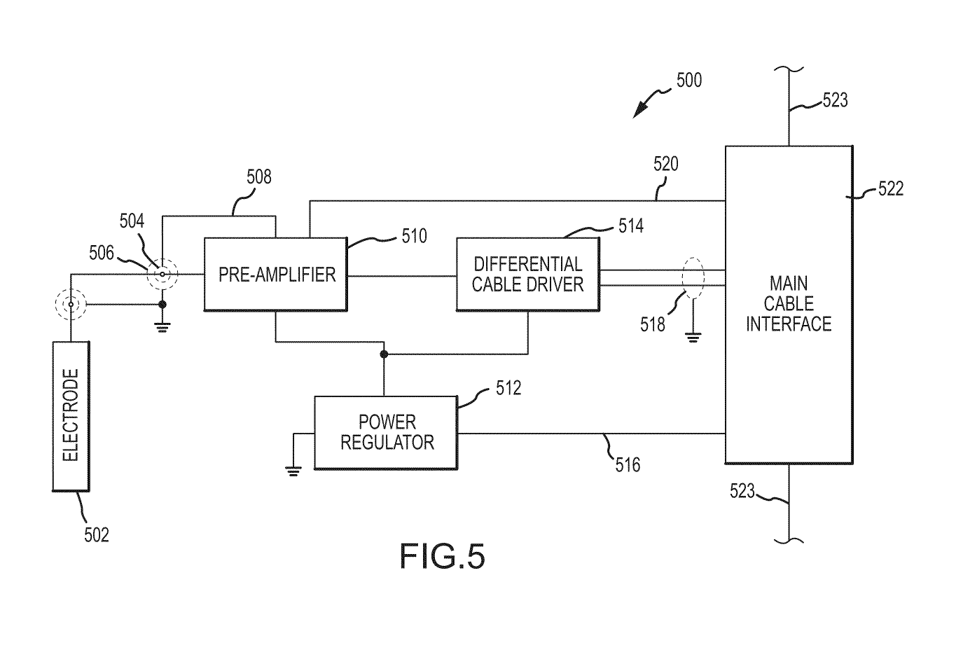

FIGS. 5-9 illustrate different implementations of the sensor nodes. As discussed with regard to FIG. 2 and FIG. 3, plurality of sensor nodes may be used in the monitoring well of the present invention. Additionally, the sensor node may be combined with other sensor node types (acoustic, accelerometer, geophone, etc.) to comprise a sensor array within the monitoring well. The sensor nodes are used within the monitoring wells and may be connected to a main cable through the main cable interface 522. Different implementations of the sensor nodes may be used. For example, a mixture of digital sensor nodes and analog sensor nodes may be used. As is more often the case, the sensor nodes may all be analog or may all be digital. When the sensor node is an analog embodiment, each sensor node may be connected to its own twisted shielded pair for driving the analog signal that results from the measurement through the main cable interface 522 to the main cable 523 to the surface. A differential line receiver may receive the signal over the main cable 523 and provide the information to the real-time acquisition system. The digital sensor node may have a different number of twisted shielded pairs that may depend on the communication system. It is also understood that in the digital sensor node implementation, error correction may be accomplished through coding.

FIG. 5 illustrates a single electrode node 500. The non-polarizing electrode 502 may be connected through a triaxial cable 506 and a driven shield 504 to a pre-amplifier 510. The pre-amplifier 510 may include a shield driver. To have the greatest precision of measurement, the pre-amplifier 510 should have very high input impedance (greater than about 10Ω) to minimize internal sensor electronics leakage currents that may cause measurement errors. The main analog signal reference 520 provides a stable, low noise, very low impedance reference voltage to the analog preamplifier and sensor linear analog electronic circuits throughout the system. This reference voltage may be of any reasonable magnitude, including about zero volts as needed by the system design to maximize analog signal integrity. The main analog signal reference 520 is the voltage reference for all analog electronics in the system. This stable, low noise reference may be generated through an electronic feedback control circuit that actively controls the voltage of the reference potential. The main cable interface 522 is an electro-mechanical interface that connects individual sensor electronics to the main cable 523. The main cable 523 connects a plurality of sensors to the sensor receiver interface circuits. The main cable 523 may provide power, signal references, signal communications, timing, control, and/or weather proof mechanical strength (as needed) to support the sensors and/or related electronics. For monitoring wells, the main cable 523 is capable of supporting the suspended weight of a plurality of sensors and electronics within the monitoring well.

The shield drive signal 508 provides sensor and sensor cable capacitance nulling to reduce external interference coupling to the input of the preamplifier circuit. Power may be provided to the sensor electronics through a power regulation device 512, which receives power from the main cable interface 522 through the main analog power feed 516. Voltage based sensor signals from the preamplifier 510 may be provided to the differential cable driver 514 for analog signal transmission through the main cable. A single twisted shielded pair 518 of many within the main cable 523 is used to transmit a single sensor signal through the main cable interface to the sensor receiver interface circuits where the differential signal is received and presented to the digitizer system. In an analog sensor signal embodiment, each sensor 500 may interface its analog measurement signal through a different twisted shielded pair 518 within the main cable 523. The twisted shielded pairs 518 inside the main cable 523 of the analog signal embodiment are used to transmit the analog sensor signals in a low noise, low impedance manner that will reduce the distortion of the measured signals by external influences. The analog signal embodiment may not work properly without a twisted shielded pair cable design.

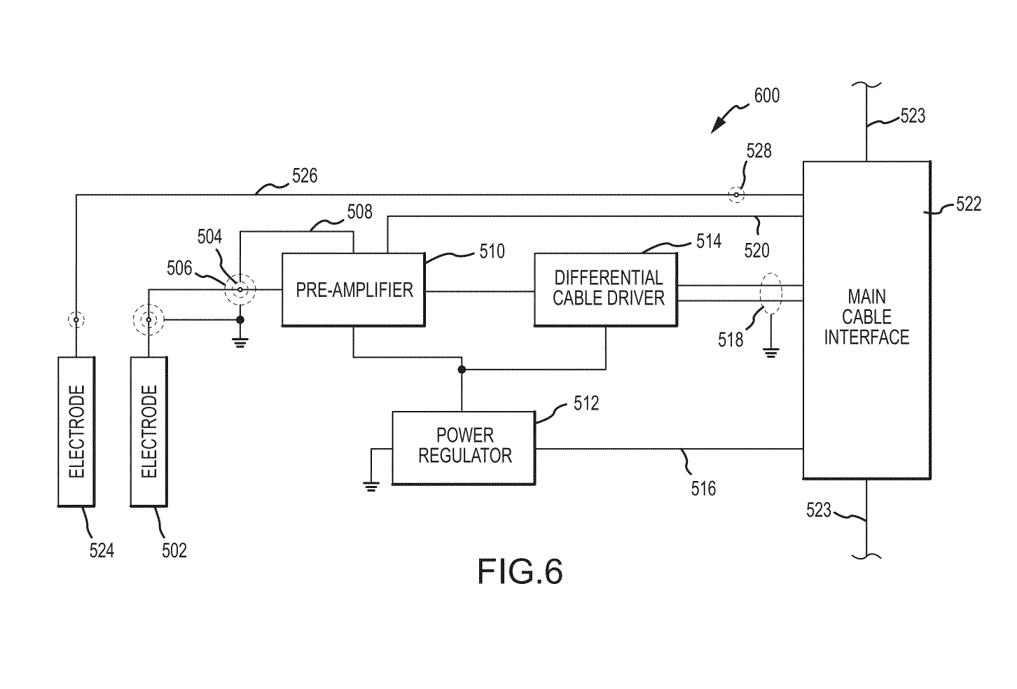

FIG. 6 illustrates a dual electrode node 600. FIG. 6 illustrates many of the same devices used in the single electrode node 500 of FIG. 5, but adds a polarizing electrode 524, current source cable 526, and coaxial ground 528. Current may be supplied to the polarizing electrode 524 through the main cable interface 522 and the current source coaxial cable 526. The current for the polarizing electrode 524 is supplied through one of many shielded conductors in the main cable 523. The shield 528 part of the coaxial cable 526, for the polarizing electrode 524 is connected to a ground reference for shielding purposes in the multiplexed current source at the top of the main cable 523, residing within the sensor array interface surface electronics.

The advantage of using polarizing electrode 524 and the non-polarizing electrode 502 within the same node, is the improvement in non-polarizing electrode stability for voltage measurement purposes. Eliminating current injection through a non-polarizing electrode reduces the possibility of thermal and chemical instabilities generated by driving current through the electrode. These instabilities may depend on various non-polarizing electrode chemistries that may be used in the non-polarizing electrode 502 design, and cause errors in the voltage output of the electrode. Errors in the electrode output voltage from these instabilities cause errors in the sensor node output. Advantageously, dual electrode nodes separate the voltage measurement and current sourcing functions inside the dual electrode node 600. This allows for injecting current into a polarizing electrode 524, versus a non-polarizing electrode 502, which eliminates instability in the non-polarizing electrode voltage output during measurement periods. Furthermore, the dual electrode node 500 allows for injecting current and measuring voltage within the same node at the same time.

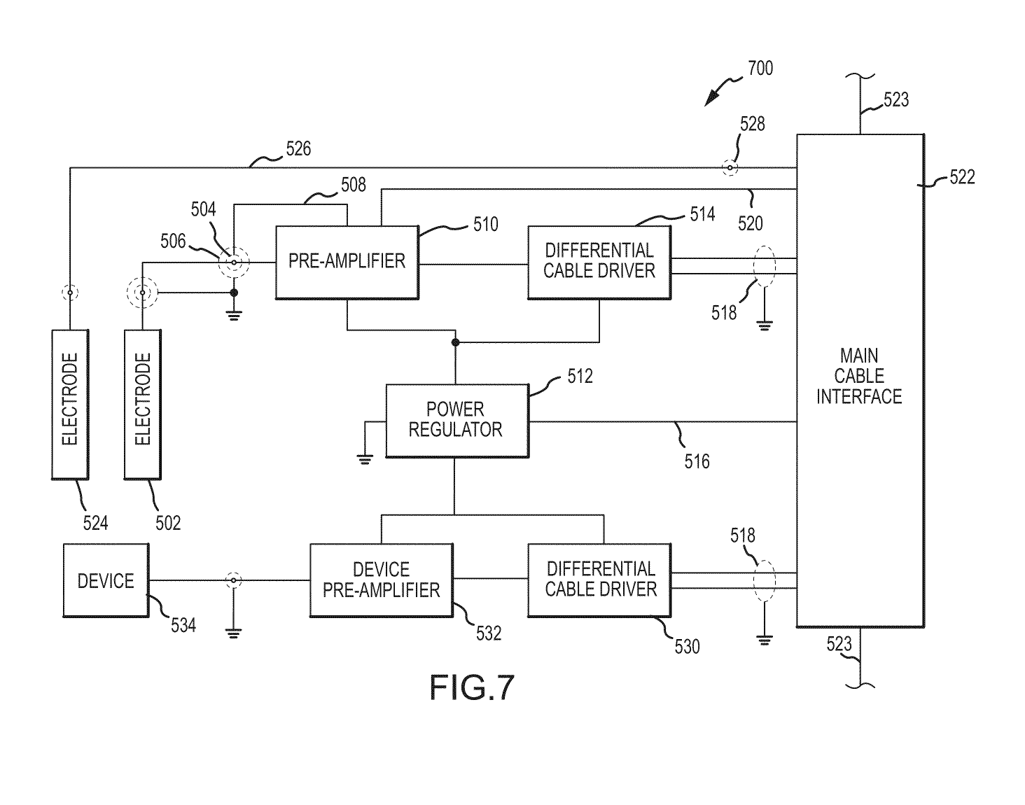

FIG. 7 illustrates an analog dual sensor 700. FIG. 7 illustrates many of the same devices used in the dual electrode node 600 of FIG. 6, but adds device 534, a device preamplifier 532, and a differential cable driver 530. The device 534 may be a vector magnetometer, geophone, a hydrophone or an accelerometer. Multiple devices may be used without deviating from the invention. A geophone may convert particle motion into voltage. The voltage may then be used in a voltage measurement. A hydrophone may convert a sound signal to an electric signal which may be used in a voltage measurement. A vector magnetometer converts magnetic field signals into voltages. A vector magnetometer may have three or more separate sensor outputs. A differential cable driver transforms a signal from a single wire form into a two wire form with opposite polarities being supplied to each wire. It also transforms the signal into a lower impedance value for transmission down a twisted shielded pair inside the main cable. In a fully analog sensor array embodiment, each sensor may have its own preamplifier, differential cable driver, and/or twisted shielded pair within the main cable. The device preamplifier 532 amplifies the signal from the device 534. Multiple preamplifiers 532 may be used without deviating from the invention. The device 534 and device preamplifier 532 may be powered from the main cable interface 522. Alternatively, the device 534 and device preamplifier 532 may be powered from the power regulation device 512.

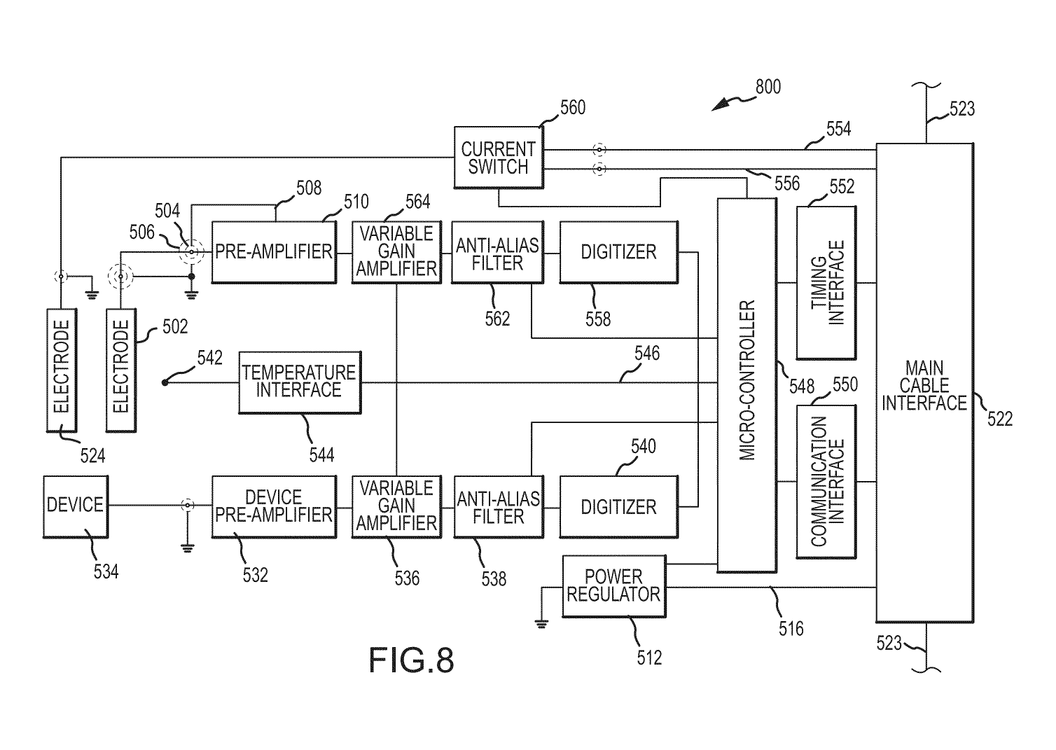

FIG. 8 illustrates a digital dual sensor 800. FIG. 8 illustrates many of the same devices used in the analog dual sensor 700 of FIG. 7, but adds digital equipment. FIG. 8 is also similar to FIG. 2, however adds equipment, including the device 534, the device preamplifier 532, the variable gain amplifier 536, the anti-alias filter 538, and the converter 540. The digital dual sensor 800 includes a digitally controlled current switch 560 for controlling whether current will be sourced or sunk at a particular sensor node. In the digital sensor node 800 embodiment, there are not multiple shielded wires capable of sourcing resistivity current to the sensor nodes, instead, there will be only two wires, a single (or multiple wires to improve current carrying capacity) positive current source bus connection for injecting current, and a single negative current source bus connection 556 for sinking current. The negative current source bus connection 554 is for sinking the exact opposite current as the positive current source bus. Only one sensor node 800 will be switched to the positive current source bus to source current, and only one other sensor node will be switched to the negative current source bus to sink current during any particular resistivity measurement period. Though this concept simplifies overall cable construction, it requires digital equipment inside the sensor node 800 to provide the switching of the current (either positive or negative) to the polarizing electrode 524. In other words, the digitally controlled current switch 560 is connected to the main cable interface 522 through a negative current source bus connection 556 and a positive current source bus connection 554. The digitally controlled current switch 560 also interfaces with a micro-controller 548. The micro-controller 548 controls various interfaces within the digital node 800. For example, the micro-controller 548 may control the digitally controlled current switch 560, the digitizer 558, the digitizer 540, the anti-alias filter 538, the temperature measurement interface 544, the power 512, the communications interface 550, and/or the timing interface 552. At least one temperature sensor 542 may be located near the non-polarizing electrode 502. The temperature sensor 542 connects to a temperature measurement interface 544. The temperature measurement interface 544 provides the necessary analog signal conditioning of the temperature sensor voltage or current signal for digitization, and may also digitize the temperature signal before presentation to the microcontroller 548. In some embodiments, the microcontroller 548 may have a digitizer embedded within it. A system interface bus 546 may be used within the node 800 and is a parallel signal pathway for multiplexing digital signals to the microcontroller 548. Information from the preamplifier 510 may be provided to a variable gain amplifier 564. The variable gain amplifier 564 may vary the gain dependent upon a control voltage or digital control signal. An anti-alias filter 562 may be used to restrict the bandwidth of a signal to a digitizer 558. The digitizer 558 converts an analog signal to a digital signal. The digital signal from the digitizer 558 may be provided to the microcontroller 548.

The signal from the device preamplifier 532 may be provided to a variable gain amplifier 536. The variable gain amplifier 564 and the variable gain amplifier 536 may be the same, or may be different devices. The signal exiting the variable gain amplifier 536 may enter an anti-alias filter 538. The anti-alias filter 538 may be the same as the anti-alias filter 562, or they filters may be different devices. The signal from the anti-alias filter 538 enters a digitizer 540, where the signal is converted from analog to digital. The converter 540 may be the same converter as the converter 580 or may be different converters. The converted digital signal is provided to the micro-controller 548.

Power to the sensor node is provided from the main cable interface 522 through the main power feed 516 and the power regulation device 512. Power may be supplied throughout the system through the main cable.

As previously explained, the sensor nodes in the overall system (i.e. all of the nodes connected to the main cable 523) should be synchronized to prevent or minimize measurement skew. The communications interface 550 provides electronic devices that interface to the main cable communications bus, which is a bidirectional duplex communications scheme with a data clock channel. There are numerous serial data protocols known in the art for this type of communications, and many different microcontrollers support many different protocols and hardware implementations for data and command communications. Some amount of timing information comes with these data protocols; however, the synchronization requirements for the data acquisition skew minimization may require a different degree of synchronization than that provided by the communications network. Optionally, a separate timing channel may be used that would provide a higher degree of timing synchronization than what would be available through the communications system. This means that the timing signal may be separate and may require a special circuit to accomplish the sensor node data acquisition synchronization. This separate timing channel may use a specially modulated clock that carries specific sync codes and other clock modulations to convey timing data or synchronization information. The timing interface may decode the timing signal, and provide the necessary synchronization signals to the sensor node to synchronize data acquisition and clocks. The timing channel and sensor node synchronizer controls the master timing in the system. At the top of the sensor system, there may be a master timing generator that encodes timing information onto a timing channel. It should be noted that all of these signals may be differentially driven and received at the sensor node interfaces, both the timing channel and the communications channels. For very long distances from one end of a sensor system to another, the timing delay within the system may need to be calibrated and corrected minimize timing based errors to keep measurement skew at a minimum. A wide variety of timing skew minimization methods may be applied individually or in any combination, including wired, wireless, and fiber-optic timing communication channels. The principal function of timing synchronization is to account for the time delay of different parts of the system and adjust the timing signals sent out to the system elements requiring timing alignment to minimize timing induced errors.

It is understood by anyone knowledgeable in the art of digital communications that there may be a need for communications signals to be received, amplified, and retransmitted. This capability constitutes a fundamental repeater function. It is also recognized that the repeater function may include functionality beyond just receiving, amplifying, and retransmitting data signal(s). In this context data signals includes, but is not limited to actual data, command, timing, and/or other digital communications related functions or channels. More complex repeater functions may include but not be limited to temporary data storage, double buffering, error detection and correction functions, cable termination and load balancing, signal integrity and noise measurement and reduction measures, decoding, and encoding operations, timing arbitration, and other communications functions.

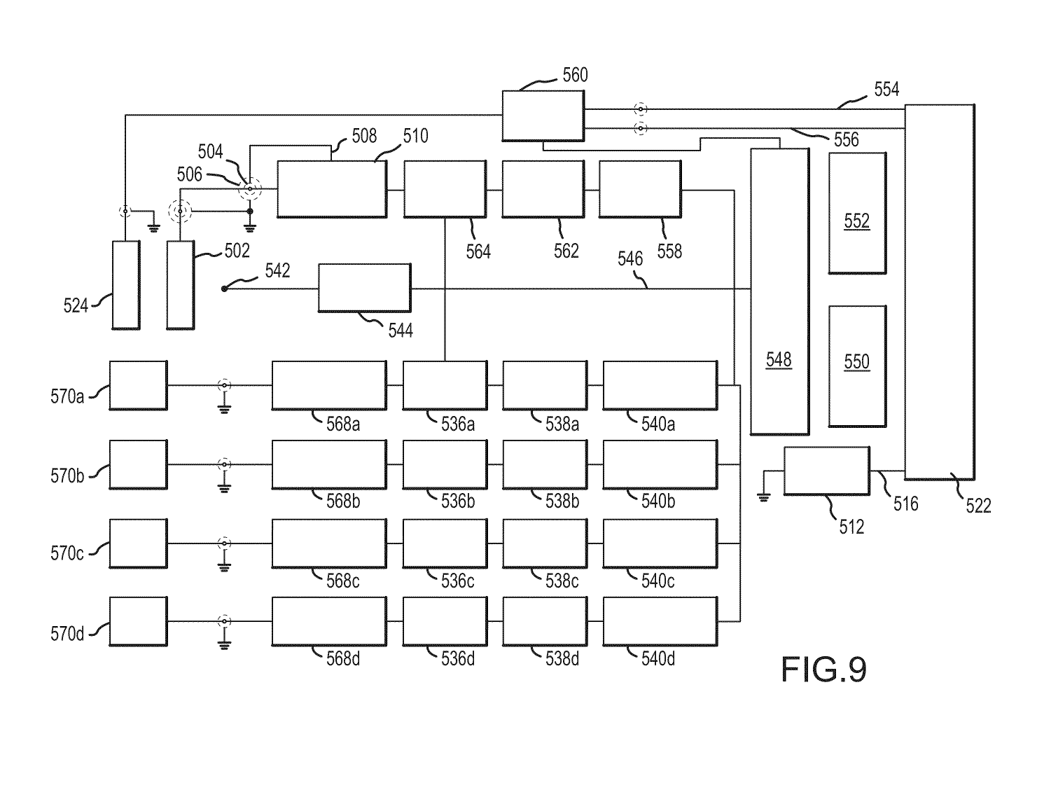

FIG. 9 illustrates a multi-sensor node 900. The multi-sensor node 900 simplifies the aggregation of data from multiple sensors, facilitating sensor data acquisition timing synchronization for the sensors associated with a multi-sensor node 900. FIG. 9 illustrates many of the same devices used in the digital dual sensor 800 of FIG. 8, but adds multiple sensors. FIG. 9 illustrates multiple devices as device 570a, 570b, 570c and 570d. Though four devices are illustrated in FIG. 9, it is understood that there could be any number of devices without deviating from the invention. In some embodiments, there are at least two devices. In some embodiments, there may be between one to about four devices; however there is no limitation on the number of sensors up to a sensor node internal space, resource allocation, or timing related limitation. The devices 570a, 570b, 570c and 570d may be vector magnetometers, hydrophones, geophones, and/or accelerometers or a combination of these devices. The devices 570a, 570b, 570c and 570d may be the same type of device or they may differ. The signal from the device passes through a preamplification device 566, 566a, 566b, 566c or 566d, respectively. It is understood that the number of preamplifiers would correlate with the number of devices. The amplified signal may then pass to a variable gain amplifier 536a, 536b, 536c and 536d. The variable gain amplifier 536a, 536b, 536c and/or 536d may be the same variable gain amplifier 564. The anti-alias filter 538a, 538b, 538c and/or 538d may be used. The filtered analog signal may be converted to a digital signal in a digitizer 540a, 540b, 540c and/or 540d. The converted signal may be sent to the micro-controller 540.

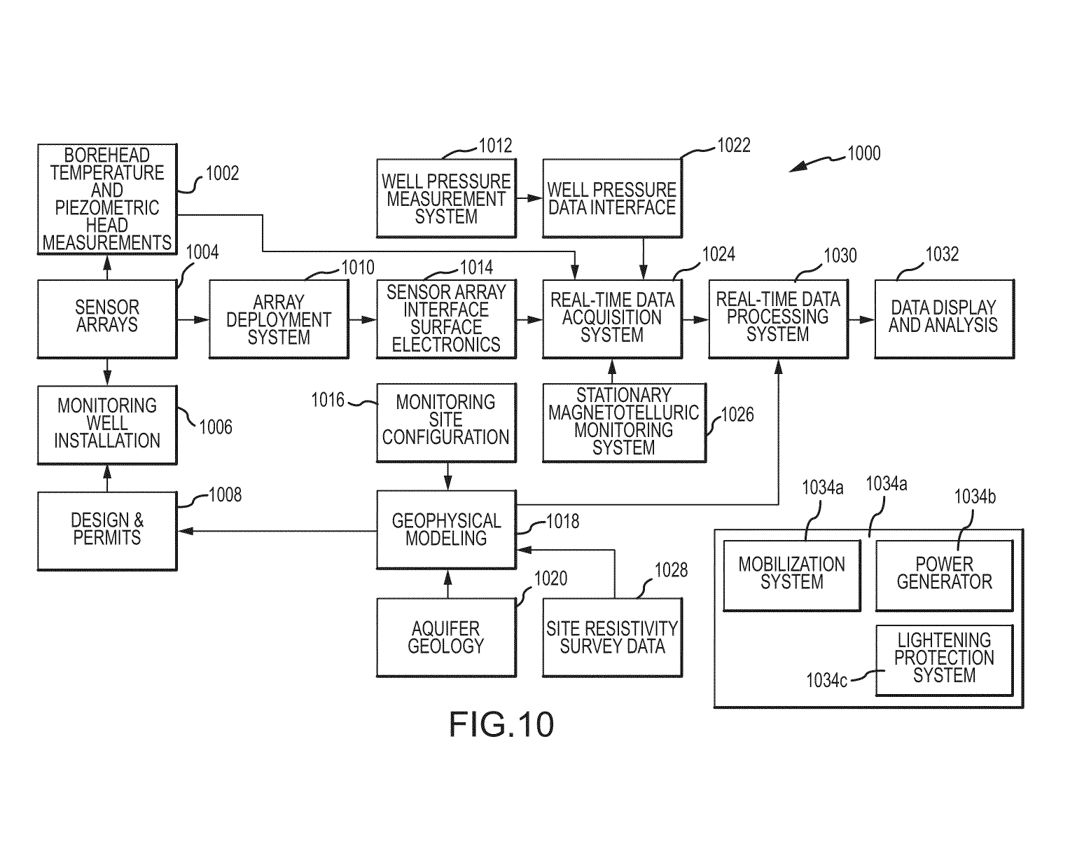

FIG. 10 illustrates a flow diagram and well monitoring system 1000, which integrates industry information to a well monitoring system 1000. FIG. 10 illustrates an oil and gas well monitoring system, though it is understood that any potentially contaminating industry data may be integrated into the well monitoring system 1000. In this embodiment, oil and gas well pressure measurements 1012 are integrated into the oil and gas well pressure data interface 1022. The oil and gas well pressure data interface 1022 may also contain galvanic isolation components, to isolate the separate oil and gas well systems from the monitoring system 1000.

The galvanic isolation components account for the different ground references in each system, and electrical currents that may be induced or injected into the subsurface, causing the ground references to be different. The galvanic isolation components may therefore prevent damage to either system. The oil and gas well pressure measurements are integrated into a real-time data acquisition system 1024.

The real-time data acquisition system 1024 may have several different embodiments that depend on the sensor array 1004 (digital, dipole, analog, etc.). In the case of the analog sensor nodes, the data acquisition system may have a digitizer per sensor node, and convert the analog signals from each analog sensor node into digital data. The digital data from each digitizer is then presented to the main data processors. The oil and gas well data would optimally be digitally acquired and digitally multiplexed with the digital sensor data. Otherwise these signals would also be digitized before being digitally multiplexed into the data stream. Another embodiment of the real-time data acquisition system 1024, the digital data from the digital sensor nodes to be processed through the communications system, and integrate the data or digitally multiplex the data with other digital data sources from other sensors within the system.

The monitoring system 1000 architecture utilizes many functional blocks that are connected together to form a logical system. Each monitoring system may require somewhat different configurations, depending on several factors. The monitoring system 1000 configuration begins with the development of a numerical geophysical model 1018 of the monitoring site. This geophysical model 1018 is constructed with inputs from the aquifer geology 1020, site resistivity survey data 1028, and monitoring site specific knowledge 1016 concerning the monitored well(s), any surface configurations related to well construction, electrical utilities, and other existing surface and subsurface characteristics such as existing wells, buildings, fences, pipelines, roads, etc. This information is integrated together to produce the geophysical model 1018 that may be used to design the specific monitoring system configuration 1008, and used in the real-time data processing system 1030 for leak signal detection and localization. The monitoring system well designs and permits 1008 may require permitting from local authorities that govern monitoring well design and installation. The monitoring wells will be designed according to the local requirements for monitoring wells. The permits for drilling the monitoring well(s) 1008 will also be requested by the monitoring company and granted or allocated as needed by the authorities pursuant to regulatory conformance. Upon approval of the well(s) designs by local authorities, potentially contaminating well operators, land owners, and/or any other stakeholders, monitoring well(s) installation 1006 proceeds. Upon completion of the monitoring well(s) installation 1006, sensor array(s) 1004 may be deployed into the monitoring well(s) with the array deployment system 1010. The array deployment system 1010 may be composed of various embodiments of winches, cables, pulleys, and other supporting devices that may mechanically handle the sensor array(s) 1004 with properly designed supporting structures to support the mechanical loading caused by the full weight of the sensor array(s) 1004 as they are fully deployed into the monitoring well(s). The array deployment system 1010 allows the sensor array(s) to be precisely positioned within the monitoring well(s), to facilitate the detection of leakage signals. The array deployment system 1010 must also provide a properly incremented measurement of the deployment depth of the sensor array(s) 1004.

Information from the sensor arrays 1004 passes through the surface electronics 1014 and may be provided to the real-time data acquisition system 1024. The surface electronics 1014 is a signal transformation interface. Its functionality may be different for various implementations of the sensor node embodiments. In some embodiments of 1014, there may be analog differential line receivers to collect the analog signals from analog signal based sensor array(s) 1004 and condition them for use in real-time data acquisition system 1024 embodiments using digitizers. Another embodiment of 1014 may include digital communications receivers and de-serializers for converting bit serial sensor data into bit parallel words for use in the digital data acquisition embodiment of 1024. A necessary function of the surface electronics 1014 is to provide galvanic isolation between the sensor array(s) 1004 and the other electronics in the system. This protects the different system components from damage due to electrical power surges or other potentially damaging events.

Borehole temperature, piezometric head, and monitoring well(s) pressure measurements 1002 from the sensor arrays 1004 or monitoring well(s) pressure may also be provided to the real-time data acquisition system 1024. Information from a stationary magnetotelluric monitoring system 1026 may also be provided to the real-time data acquisition system 1024.

The real-time data acquisition system 1024 may receive information from the borehole temperature and piezometric head 1002 (a well water depth sensor), the surface electronics 1014, the stationary magnetotelluric monitoring system 1026, and the oil and gas well pressure interface 1022. The combined data may be processed in the real-time data processing system 1030 using the geophysical model from 1018. The information from the real-time data processing system 1030 may be displayed and analyzed in the data display and analysis 1032 function.

The operations support systems 1034 includes functionality to allow the monitoring system 1000 to be transported to the monitoring well site provide power, facility for external wireless and/or wired communications, and lightening protection. These elements are not directly involved in the data acquisition, processing, and analysis of the various sensor signals. These equipment items are necessary to support the monitoring system operation, and as such are separated from the rest of the functional blocks. Furthermore, the operations support equipment may include a wireless and/or wired communications block that interfaces with the monitoring system network. This wireless and/or wired communications block may include access to various external wired networks, including but not limited to wired telephone or telecommunications employing DSL, cable based networks, ethernet, cellular connections to a commercial cellular network, wireless local networks, wide area networks, satellite communications, or other wireless and/or wired digital and/or analog communications systems and may include various two way radios. This wireless and/or wired communications block may provide voice, digital, or analog telemetry capability as needed to remotely control, monitor acquired data, check processing results, check health and status of the monitoring system 1000, provide data for off-site processing, and/or voice communicate with any human operators that may be at the monitoring system deployment site. Additionally, other wireless functionality may include data and/or voice communications with well operators and relevant subcontractors, and/or well regulators, and/or land owners, and/or other stakeholders in the monitoring operations. It also may be necessary for the well monitoring personnel at the monitoring system deployment site to communicate via voice for system installation and/or operations support using various two way radio and/or wired systems.

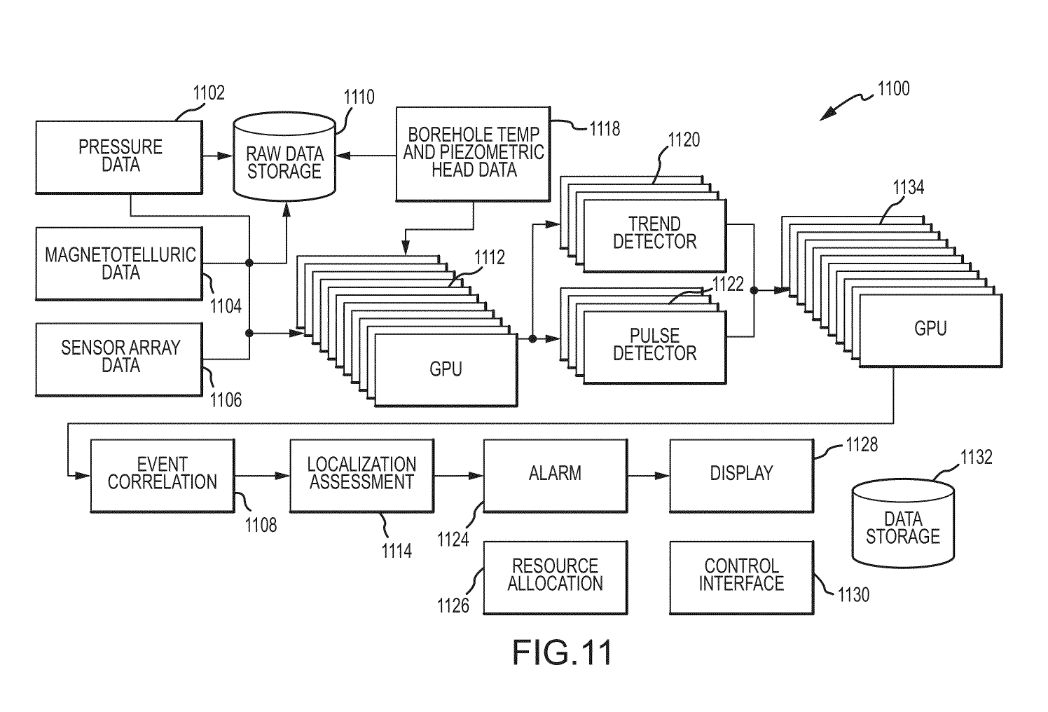

FIG. 11 illustrates a real-time data processing flow diagram for a multi-processor 1100 embodiment of the real-time data processing function. Pressure data 1102 from both the monitoring well(s) and the monitored well(s) (part of the oil and gas well interface data stream), and/or magnetotelluric data 1104, and/or sensor array data 1106, and/or borehole temperature and piezometric head data 1002 may be stored in a raw data storage database 1110. Pressure data 1102 and/or sensor array data 1106, and/or magnetotelluric data 1104, and/or borehole temperature and piezometric head data 1002 may be provided to a graphic processing unit (GPU) 1112 for digital filtering, DC offset correction, temperature and/or drift correction. GPUs may be used to process sensor data in parallel. Information from the GPU 1112 is provided to the trend detection 1120 and/or the pulse detection 1122 functions. The trend detection 1120 function scans the data, looks at historical data records to detect subtle trends in the sensor data. Subtle trends in the data could indicate the presence of leaks that do not have impulsive characteristics. The magnetotelluric corrections are crucial to be able to detect any subtle trends that may exist in the signals. The pulse detection 1122 function scans through the sensor data to look for impulsive events that may be an indication of a progressive seal failure or a catastrophic seal failure that is sudden in its manifestation. Information from the trend detection 1120 and/or pulse detection may be processed in the GPU 1134 for voltage data signal inversion and localization using the geophysical model 1018. Information from the GPU 1134 may be used to correlate possible leak data related events found by the GPU processing 1134 function with other sensor data such as pressure changes, acoustics, magnetometers, and/or geophones from the monitoring system well(s) or from the monitored well(s) data. If a correlation exists between various sensor data sets then the correlation is flagged as an event by the event correlation 1108 function. Event correlation is a temporal alignment analysis function that evaluates sensor data for characteristics that align in time with each other, indicating a possible common origin. The correlated event 1108 information may be used by a data assessment system 1114 to assess whether some signals possibly originate inside or outside system bounds. If information is determined to be outside the bounds defined by the geophysical model 1018, then an alarm 1124 may not be displayed on a graphical display 1128 as a possible leak source, but the information may still be displayed on the graphical display 1128 for further analysis. If the information is determined to be within the bounds defined by the geophysical model 1018, the alarm 1124 would be displayed as a possible leak that needs further verification or as a confirmed leak. It is understood that the geophysical model 1018 bounds may be set such that the alarm 1124 may be triggered if information determined to be outside of the bounds defined by the geophysical model 1018 possibly indicates some sort of potential harm circumstance that was not incorporated into the geophysical model 1018. This type of event may occur from a leak that formed deeper in the monitored well(s) vicinity, outside the geophysical model 1018 boundary, that generated signals that were detected by the aquifer monitoring system. Given that this type of leak may be below the monitored, and protected zones, and may represent a future undesirable intrusion event into the protected areas, other leak localization methods may be employed to localize the deeper leaking zone. Further verification or analysis may involve retrieving the raw data 1110 and verifying that the sensor signals had characteristics that are consistent with known leak phenomena. If a new characteristic is found, then the results of the analysis can be added to the leak characteristics database 1224 within the data storage 1132 element. The data storage element is used to store well leakage detection data, related sensor data time segments, analysis results, and generated reports. In general, the raw data 1110 is a large archival data storage system for storing all of the raw data acquired during monitoring. It may be implemented as a RAID array of disk drives or other suitable means. This data will be used to recall time segments as needed for quality control, monitoring system operator training, system operations verification, and as evidence for legal proceedings. This data will be moved into a permanent mass data storage system 1132 for later retrieval as needed for legal procedures concerning leaking wells and/or as test data for leak detection and localization algorithm development and testing, and monitoring system training.

All multiprocessor based computing systems require dynamic computing resource allocation 1126. This includes processor and memory assignments to specific data processing algorithms, disk space allocation, process priority control, thermal control, and display resource control. This resource allocation improves the use of the computing resources to maximize data throughput and minimize power consumption when resources are not needed.

The system control interface 1130 is the visual display of the health and status of the functioning of the monitoring system. It is updated in real-time to display possible sensor problems, data flow problems, computing problems, and all other system status parameters, including power consumption, sensor array deployment depth, noise levels, and more. This function also allows various performance parameters of the monitoring system to be adjusted as needed during monitoring system operation. The data for this function is provided by many different elements in the system, including the computing resource allocation 1126 function, the sensor array 1004 system, array deployment system 1010, sensor array interface electronics 1014, real-time data acquisition system 1024, stationary magentotelluric monitoring system 1026, pressure data 1102, borehole temperature and piezometric head data 1002, and more. This composite monitoring system health, performance, and operations status is stored along with the raw data 1110 in the data archive. This data may also be stored in the data storage 1132 element for direct use in system status and performance reports.

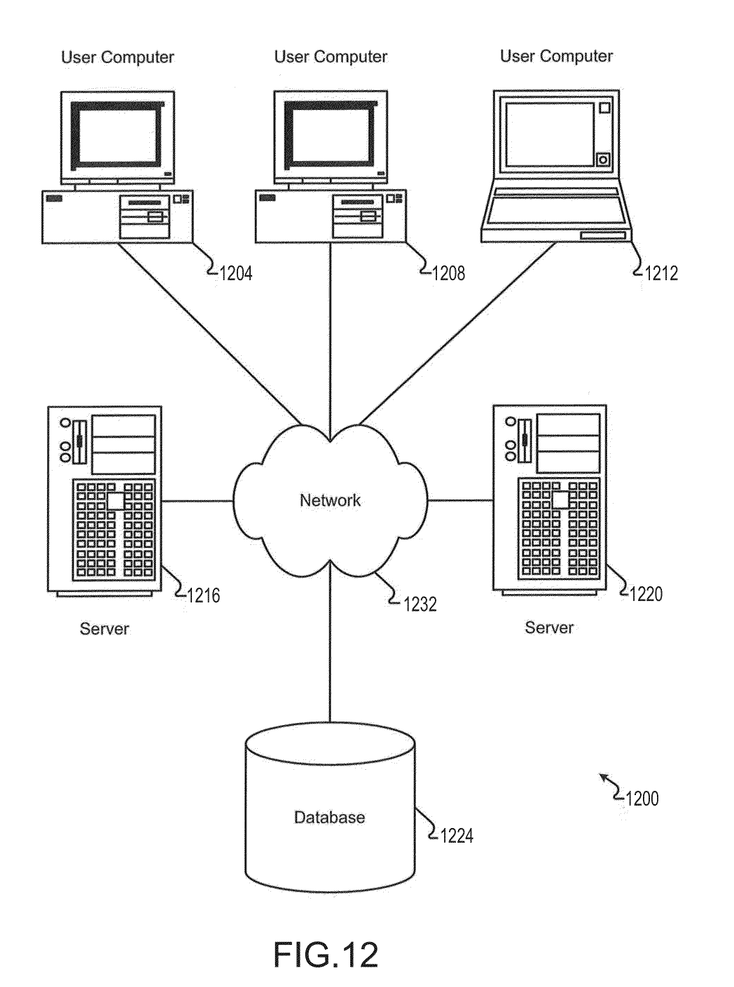

Referring to FIG. 12, a block diagram of a network system 1200 that may be utilized in conjunction with embodiments of the present disclosure is provided. The system 1200 includes one or more user computers 1204, 1208, and 1212. The user computers 1204, 1208, and 1212 may be general purpose personal computers (including, merely by way of example, personal computers and/or laptop computers running various versions of Microsoft Corp.'s Windows™ and/or Apple Corp.'s Macintosh™ operating systems) and/or workstation computers running any of a variety of commercially-available UNIX™ or UNIX-like operating systems. These user computers 1204, 1208, and 1212 may also have any of a variety of applications, including for example, database client and/or server applications, and web browser applications. Alternatively, the user computers 1204, 1208, and 1212 may be any other electronic device, such as a thin-client computer, Internet-enabled mobile telephone, and/or personal digital assistant, capable of communicating via a network (e.g., the network 132 described below) and/or displaying and navigating web pages or other types of electronic documents. Although the exemplary system 1200 is shown with three user computers, any number of user computers may be supported including graphics processing units inside any number of computer platforms and configurations.

System 1200 further includes a network 1232. The network 1232 may be any type of network familiar to those skilled in the art that may support data communications using any of a variety of commercially-available protocols, including without limitation TCP/IP, SNA, IPX, AppleTalk, and the like. Merely by way of example, the network 1232 maybe a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, the Bluetooth™ protocol known in the art, and/or any other wireless protocol); and/or any combination of these and/or other networks.

The system may also include one or more server computers 1216, 1220. One server may be a web server 1216, which may be used to process requests for web pages or other electronic documents from user computers 1204, 1208, and 1212. The web server 1216 may be running an operating system including any of those discussed above, as well as any commercially-available server operating systems. The web server 1216 may also run a variety of server applications, including HTTP servers, FTP servers, CGI servers, database servers, Java servers, and the like. In some instances, the web server 1216 may publish operations available operations as one or more web services.

The system 1200 may also include one or more file and or/application servers 1220, which may, in addition to an operating system, include one or more applications accessible by a client running on one or more of the user computers 1204, 1208, and 1212. The server(s) 1220 may be one or more general purpose computers capable of executing programs or scripts in response to the user computers 1204, 1208, and 1212. As one example, the server may execute one or more web applications. The web application may be implemented as one or more scripts or programs written in any programming language, such as Java™, C, C#™ or C++, and/or any scripting language, such as Matlab, Comsol, Perl, Python, or TCL, as well as combinations of any programming/scripting languages. The application server(s) 1220 may also include database servers, including without limitation those commercially available from Oracle, Microsoft, Sybase™, IBM™ and the like, which may process requests from database clients running on a user computer 1204, 1208, and 1212.

In some embodiments, an application server 1220 may create web pages dynamically for displaying the development system. The web pages created by the web application server 1220 may be forwarded to a user computer 1204 via a web server 1216. Similarly, the web server 1216 may be able to receive web page requests, web services invocations, and/or input data from a user computer 1204 and may forward the web page requests and/or input data to the web application server 1220.

In further embodiments, the server 1220 may function as a file server. Although for ease of description, FIG. 12 illustrates a separate web server 1216 and file/application server 1220, those skilled in the art will recognize that the functions described with respect to servers 1216, 1220 may be performed by a single server and/or a plurality of specialized servers, depending on implementation-specific needs and parameters.

The system 1200 may also include a database 1224. The database 1224 may reside in a variety of locations. By way of example, database 1224 may reside on a storage medium local to (and/or resident in) one or more of the computers 1204, 1208, 1212, 1216, or 1220. Alternatively, it may be remote from any or all of the computers 1204, 1208, 1212, 1216, or 1220, and in communication (e.g., via the network 1232) with one or more of these. In a particular set of embodiments, the database 1224 may reside in a storage-area network (“SAN”) familiar to those skilled in the art. Similarly, any necessary files for performing the functions attributed to the computers 1204, 1208, 1212, 1216, or 1220 may be stored locally on the respective computer and/or remotely, as appropriate. In one set of embodiments, the database 1224 may be a relational database, such as Oracle 10i™, that is adapted to store, update, and retrieve data in response to SQL-formatted commands.

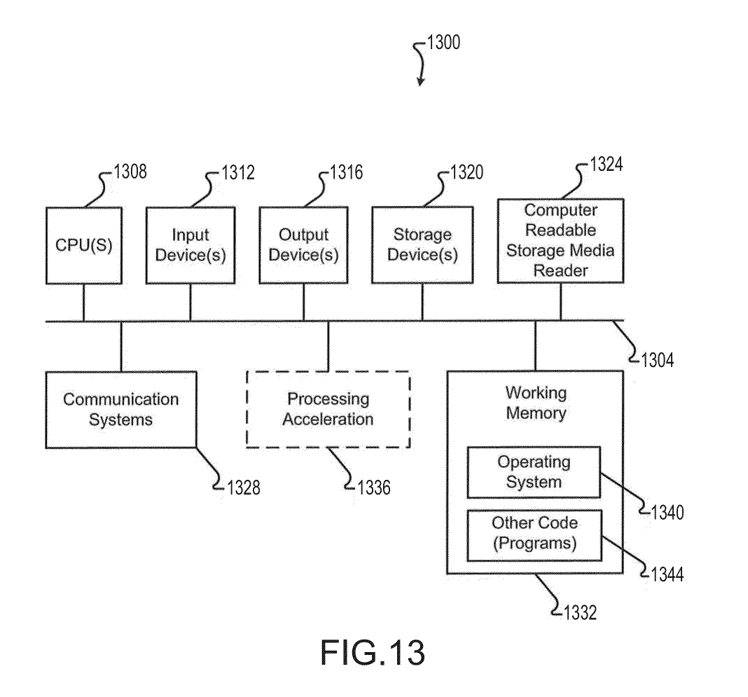

FIG. 13 illustrates one embodiment of a computer system 1300 that may be utilized in conjunction with embodiments of the present disclosure. The computer system 1300 is shown comprising hardware elements that may be electrically coupled via a bus 1304. The hardware elements may include one or more central processing units (CPUs) 1308; one or more input devices 1312 (e.g., a mouse, a keyboard, etc.); and one or more output devices 1316 (e.g., a display device, a printer, etc.). The computer system 1300 may also include one or more storage device 1320. By way of example, storage device(s) 1320 may be disk drives, optical storage devices, solid-state storage device such as a random access memory (“RAM”) and/or a read-only memory (“ROM”), which may be programmable, flash-updateable and/or the like.

The computer system 1300 may additionally include a computer-readable storage media reader 1324; a communications system 1328 (e.g., a modem, a network card (wireless or wired), an infra-red communication device, etc.); and working memory 1332, which may include RAM and ROM devices as described above. In some embodiments, the computer system 1300 may also include a processing acceleration unit 1336, which may include a DSP, a special-purpose processor and/or the like

The computer-readable storage media reader 1324 may further be connected to a computer-readable storage medium, together (and, optionally, in combination with storage device(s) 1320) comprehensively representing remote, local, fixed, and/or removable storage devices plus storage media for temporarily and/or more permanently containing computer-readable information. The communications system 1328 may permit data to be exchanged with the network 1232 and/or any other computer described above with respect to the system 1200.

The computer system 1300 may also comprise software elements, shown as being currently located within a working memory 1332, including an operating system 1340 and/or other code 1344, such as program code implementing a web service connector or components of a web service connector. It should be appreciated that alternate embodiments of a computer system 1300 may have numerous variations from that described above. For example, customized hardware might also be used and/or particular elements might be implemented in hardware, software (including portable software, such as applets), or both. Further, connection to other computing devices such as network input/output devices may be employed.

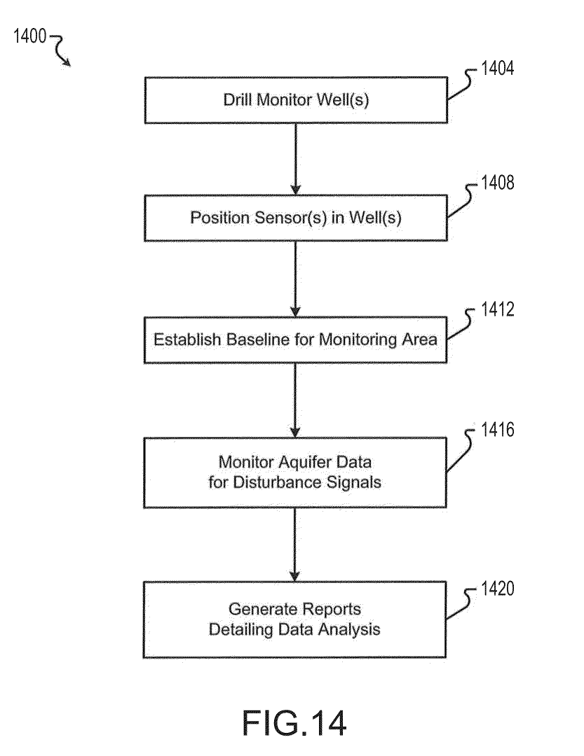

Referring to FIG. 14, a monitoring method 1400 according to one embodiment of the present disclosure is provided. At step 1404, at least one monitor well is drilled. In one embodiment, one monitor well may be drilled for each aquifer 116 being monitored. In an alternative embodiment, a plurality of monitor wells may be drilled for each aquifer 116 being monitored. In another embodiment, any monitoring well may also intercept one or more aquifers and as such may be used for monitoring multiple aquifer zones. At step 1408, at least one sensor is positioned in each monitor well. In one embodiment, a plurality of sensors is positioned in each monitor well. At step 1412, before any potentially contaminating operations are started, a baseline for the desired monitoring area is established. For example, a baseline three-dimensional DC resistivity survey may be performed in the area of interest to be monitored, and the resistivity tomogram of the subsurface may be computed. Induced polarization, complex resistivity, and/or spectral induced polarization measurements may also be performed either with, or as a substitute for DC resistivity measurements. Subsequently, pressure and electrical potential monitoring may commence to establish a baseline temporal history of pressure and electrical potential. This baseline data may be used to establish electrical and pressure noise background levels, electrical and pressure transient characteristics, and hydrostatic and spatial voltage distributions within and around the monitored volume. In addition, the resistivity tomogram may be used to localize all background electrical distributions, both DC and transient, within the monitored volume. Normal aquifer behavior is recorded prior to the commencement of potentially contaminating operations to account for typical and normal disturbances, including, but not limited to, pumping of drinking water and local volume recharge characteristics. The duration of this data acquisition period may be dependent on but not limited to aquifer usage, well construction phase duration, well operations, and time needed to monitor abandoned well(s) for leakage.

At step 1416, the data acquired from the sensors 124 is monitored for disturbance signals. For example, upon commencement of potentially contaminating operations, data from the pressure sensors and electrical potential arrays may be used in real-time to identify disturbance signatures that indicate the existence of a fluid flow event, which may be related to fluid movement caused by contaminating events. In one embodiment, detected electrical disturbances are combined with the baseline resistivity tomogram and other sensor data to determine the location, in three dimensions, of any identified fluid flow event. In one embodiment, the monitoring system operates in real-time to minimize aquifer damage. For example, upon detection of intrusion signatures, contaminating operations may be stopped. For example, upon termination of the contaminating operations, pressure monitoring may continue and a combined temporal series of resistivity tomography and electrical potential monitoring may be commenced to track the extents of contamination over time. This sequence of monitoring may continue for a period of time after termination of the contaminating operations to insure that induced residual stresses do not cause additional undesirable fluid movement into protected areas. The post-termination monitoring may establish that the monitored aquifer system did or did not continue alter its behavior. In one embodiment of the system, if a leak is detected, the monitoring system may be employed to help repair the leak, and subsequently verify that the leak has been repaired by validating that the leak signature no longer exists. In another embodiment of the monitoring system, resistivity tomography data may be acquired in conjunction with electrical potential data and/or other sensor data to determine the extents of leak caused damage to the monitored aquifer or other protected geological formation. This data may be used in a report or provided as evidence of the existence or not of formation damage in a legal proceeding.

The data acquired during the monitoring operations may be analyzed by a human operator in real-time. In some embodiments, at least one geophysicist and a geologist review the data to interpret the results and assess the quality of the acquired data. In some embodiments, data quality control is an important factor in the acquisition and analysis of the data. For example, in one embodiment, suspect data is identified for more careful assessment. The human system operators may also look for problems with sensors that may develop over time and determine whether the sensor problems pose leak detection reliability issues that require field maintenance. Raw data 1110 records may be stored in files using a standard data format that records pressure, voltage, temperature, time, and other relevant data acquisition parameters. In some embodiments, the raw data 1110 files are kept for many years in a database, which may be securely archived, after acquisition.

At step 1420, reports are generated detailing the analysis and interpretation of the monitoring data. These reports certify whether aquifer fluid flow events correlate with potentially contaminating operations. For example, the reports may indicate a high probability that undesirable fluids and/or gases penetrated into the monitored volume during or after potentially contaminating operations. The processed data, which may include acoustic, magnetic, geophone, temperature, pressure, and electrical sensor data, with source localization, resistivity inversion results, and generated reports, may be stored in database 1224 in 1132. In some embodiments, the acquired data and generated reports represent a permanent and legal record of the status of the aquifer, before, during, and after potentially contaminating operations. These reports may be certified and structured to be used as legal evidence in asserting, or defending against, an aquifer subsurface contamination allegation. To increase the credibility of the reports, an independent aquifer monitoring company may be used to record and monitor the operations. The reports may be independently submitted to the well owners, the well operator and subcontractors, the state for regulatory purposes, and other stakeholders as necessary.

Various embodiments of this system may be applied to numerous applications other than potentially contaminating oil and gas industry operations monitoring, including carbon sequestration monitoring, well cementation leakage assessment after surface casing installation and cement curing, assessment of old, operational wells and old plugged and abandoned wells for leakages, subsurface environmental remediation injection and extraction process tracking Many other applications of various embodiments of this concept will be readily apparent to those skilled in the art.

Another aspect of the invention relates to monitoring the electric potential distribution at or near a well casing. This cost effective aspect of the invention advantageously uses information related to the voltage near the well at the surface to determine if there is a leak associated with or in very close proximity to the well. The electrical potential near the casing may change due to the movement of fluids and gases that may or may not displace other fluids in close proximity to the well. The electrical signatures may be generated by a streaming current inside of a conductive porous medium in very close proximity to the well, an electro-kinetic effect. Fluid or gas leaking into an aquifer may produce a different streaming current configuration, which may generate a different spatially distributed streaming potential distribution along with spatial changes in resistivity within a zone relatively near the well in the aquifer. Part of the streaming current that may develop from a leak may electrically connect to the metallic casing of the well. This portion of the streaming current may conduct up the well and generate a voltage in the casing. The casing voltage may be used as an indication of a possible leak, and may be combined with other electrical potential and/or resistivity measurements to detect leakage and the spatial extent of the disturbance caused by the leak. The casing voltage may appear at the surface and generate a resulting voltage gradient in the formation that radiates from the casing. The casing voltage exists in superposition with other streaming potential sources within the formation. Importantly, the casing voltage distribution may provide leak detection information—i.e. whether there is a leak associated with or in very close proximity to the well, though the data may not be able to determine where the leak is spatially located relative to the well geometry. This leak detection method may be used to detect leaks outside of the casing and/or to detect leaks caused by casing corrosion, some of which may be caused by external corrosion. Furthermore, the present invention may be used with other methods of leak detection that involve pressurizing the well in a prescribed manner, using tracers, and/or other mechanical movement of fluid that is able to modulate the voltage in the well casing, aiding in the leak detection. The present invention may also be used to determine if a leak has stopped or if mitigation measures have been successful.

Magnetotelluric effects may need to be measured and compensated for to differentiate magnetotelluric induced casing potential from possible leak signatures. Additionally, any potentially contaminating operation, including but not limited to fluid injection and/or withdrawal, will need to be accounted for during the monitoring process. This can be done by a variety of different methods, including correlating known fluid flow rates and times with changes in measured casing potential, and/or the spatial distribution of surface voltages around the well(s). The voltage response due to potentially contaminating operations can then be measured and accounted for in the leak detection process. Any additional changes to the voltage response that are not related to known changes in fluid flow, and/or other disturbances may indicate a suspected leak.

The leak detection information may be used to determine if additional tests, including the use of monitoring wells, should be utilized. Thus, it is understood that this aspect may be combined with other aspects of the invention to first detect if a leak is present in a well. Then a monitoring system described in this specification may be installed and utilized to determine the location of the leak within the well.

### EXAMPLES

### Example 1

Laboratory experiments were conducted and the results of the testing are described below. The experiment used pressure and acoustic measurements.

### Set-Up

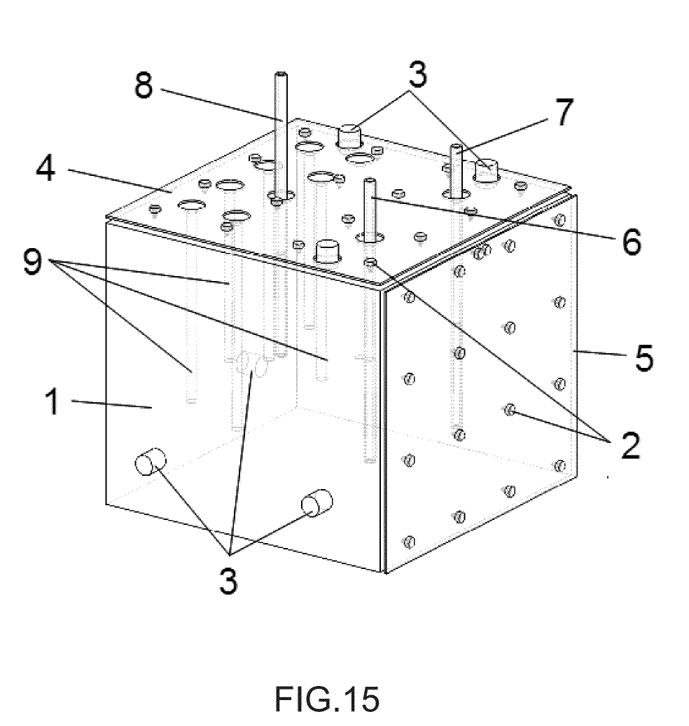

FIG. 15 illustrates the set-up of the laboratory experiment. The porous block 1 used in the laboratory tests was a cement mixture of FastSet Grout Mix that was cured for approximately ten months before the experiment. The porous block 1, which represented the testing field or aquifer field, was a cubical shape measuring about 30.5 cm by about 30.5 cm by about 27.5 cm. After curing, several holes 10, approximately 15 mm in diameter were drilled into the porous block 1 at varying depths such that various tube sealing methods could be tested. A stainless steel tube with an outer diameter of approximately 10 mm was placed into hole 6, hole 8, and hole 7 using epoxy in porous sample. The injection tube in hole 6 was secured in place and sealed with epoxy. Voltage measurement electrodes 2 were attached using with a plastic plate 4 and plastic plate 5 to the top and one side of the porous block 1 such that about 16 electrodes were on each face of the porous block 1. The electrodes 2 were composed of solid sintered silver grains with a solid silver chloride coating, forming a silver-silver chloride non-polarizing electrode. Each electrode 2 had a voltage amplifier built into the casing. The active diameter of the electrodes 2 was about 2 mm. Each of the electrodes 2 was electrically connected to the porous block with a drop of conductive gel. Acoustic emission sensors 3 were also mounted to three faces of the porous block 1. Other holes 9 were also present in the porous block 1.

### Electrical Response

The electrical response during the experiment was measured using a multichannel voltmeter (Biosemi, Inc). The electrical potential measurements were acquired with the amplified non-polarizing silver-silver chloride electrodes 2. The electrode potentials were measured using the BioSemi ActiveTwo data acquisition system that was self-contained, battery powered, galvanically isolated and digitally multiplexed with a single high sensitivity analog to digital converter per measurement channel. A 24 bit analog to digital converter was used in the system and based on a Sigma-Delta architecture. The system had a typical sampling rate of about 2,048 Hz with an overall frequency response from DC to about 400 Hz. The measurement system had a scaled quantization level of about 31.25 nV (LSB) with about 0.8 μV rms noise at the full bandwidth of about 400 Hz with a specified 1/f noise of about 1 μV pk-pk from about 0.1 to about 10 Hz. The common mode rejection ratio was higher than about 100 dB at about 50 Hz. The amplified non-polarizing electrode input impedance was about 300 MΩ at about 50 Hz (about 10¹²Ω//about 11 pF.

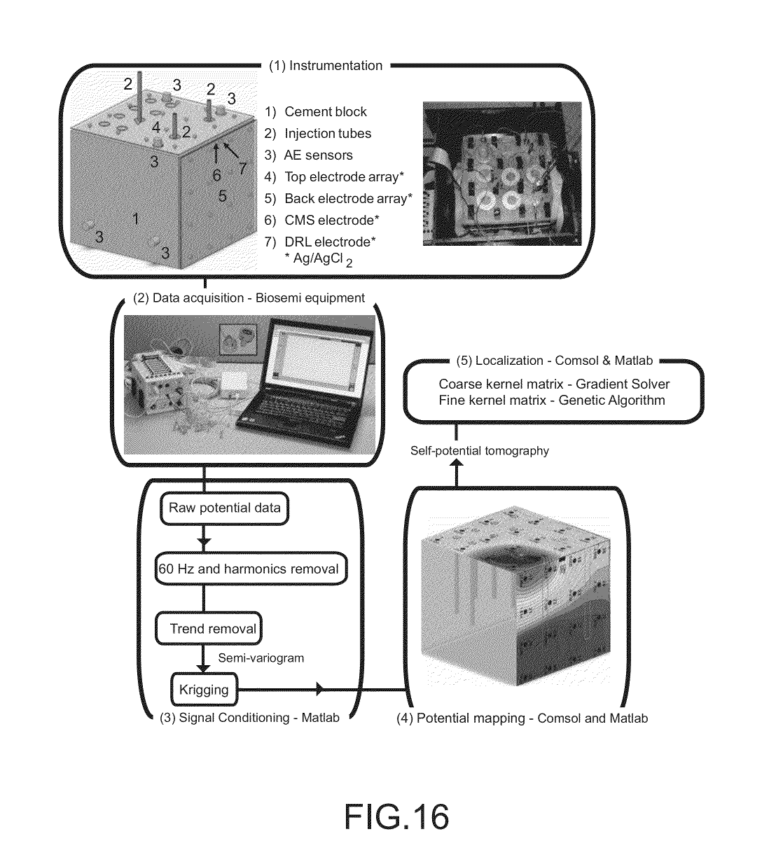

The voltage reference for the measurements was contained within the measurement area, and was designed into the measurement system to be a part of the common mode sense (CMS) and common mode range control (DRL) electrodes. In this system, the CMS electrode was a dynamic reference potential. All of the digitized data that was saved in the raw data form in the data files, and was referenced to the CMS electrode. The data was recorded with all of the common mode signals and, as a result, any channel could be used as the reference channel. FIG. 16 illustrates a flow chart for the processing of the electrical potential data.

Acoustic emissions were also monitored using Mistras WSa sensors 3. All six acoustic sensors 3 had an operational frequency of between about 100 kHz to about 900 kHz and a resonant frequency of about 125 kHz. An Acoustic Emission (AE) System (PAC's Micro-II PCI-2-8 Digital) chassis was used to run AE data collection and post-test data analysis software. The AE system chassis performs at about 40 MHz acquisition with sample averaging and automatic offset control. Waveform streaming enables data acquisition to hard disk continuously up to about 10 MHz. Single-ended AST preamplifiers were used on each channel throughout all testing. A 60 dB gain setting was preferred in order to amplify micro-fracture signals and increase signal-to-noise ratios.

The acoustic emission data were inverted to localize the position of the source within the cement block. The localization of the acoustic emissions was performed with the acoustic emission data software (manufactured by Physical Acoustics Corporation, PAC). Wideband Wsa acoustic emission piezoelectric transducers were used in conjunction with PAC's AEwin source location software and data collection system.

### Experiment 1

Experiments were conducted on the porous block 1 in equilibrium with the atmosphere of the laboratory (about 30% relative humidity). Saline water was used as the injection or fracturing fluid (without proppant, such as sand or other small particles) containing about 10 g of NaCl dissolved in about 1000 ml of deionized water (conductivity of about 1.76 S/m at about 25° C.). The concentration of salt in the system was chosen because lower salinities implied higher electrokinetic signals. The high concentration of salt used in the experiments was used to demonstrate that even at such high salinity conditions, the self-potential signals could be easily observed. The fluid control system injected fluid through stainless steel tubes in hole 6 of FIG. 15 at a controlled flow rate or pressure. The injection tube was designed to have an open end at the bottom; there were no side ports for fluid to flow through. The system has a total fluid capacity of about 103 ml, and was capable of achieving pressures up to about 68.9 MPa while maintaining constant flow rates of about 0.001 to about 60 ml/min. In this experiment, the injection tubes were pressurized to about 2 MPa with the fracturing fluid and maintained at that pressure for a period of time to be sure that the system, including the block, was maintaining pressure and to measure the fluid flow rate. A constant fluid flow rate of about 1 ml/min was then imposed on the system. Under constant flow, the porous block 1 or the tubing seal within hole 6 would eventually fail in tension unless cracks were reactivated.

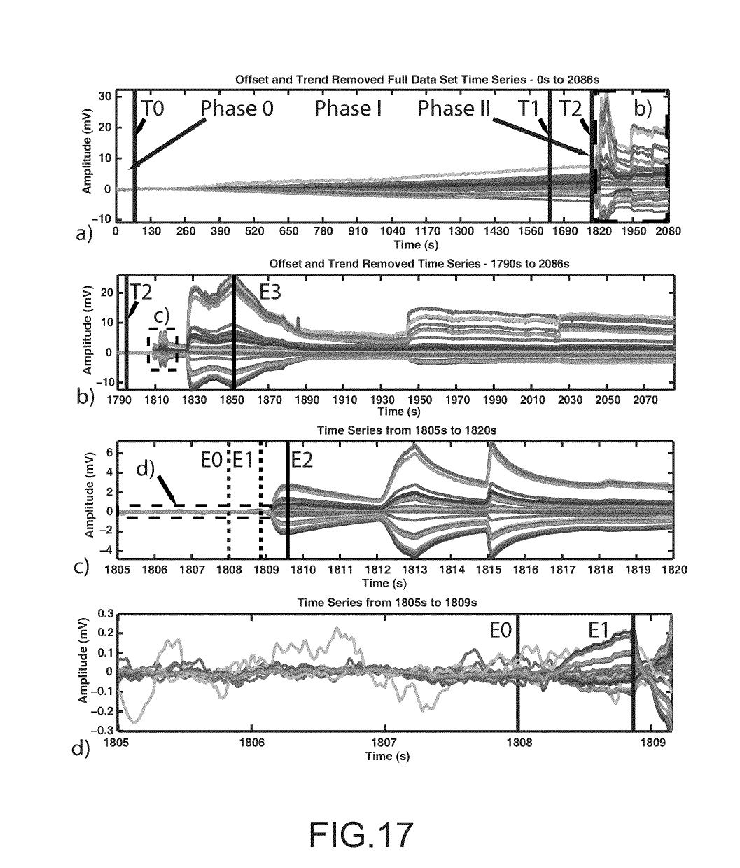

The test procedure began by preparing the cement block 1 for high pressure injection. The injector was filled with the saline solution and coupled to the injection tube that was also filled with the saline solution. The injection system was purged of air, and then subjected to constant pressure of about 13.79 MPa for about 30 minutes to monitor leak-off to be sure that there was no pressure loss. For the experiment associated with hole 6, about a 60 second pre-injection (termed Phase 0) measurement period was acquired (discussed with regard to FIG. 17a). The goal of this phase was to establish individual channel offsets and drift trends for use during post acquisition signal processing. Constant pressure fluid injection at about 13.79 MPa (termed Phase I) was initiated at T0=about 60 s and terminated at T1=about 1632 s. Phase I was followed by Phase II, an about 1 ml/min constant flow rate initiated at T2=about 1795 s (note that fluid pressure was maintained, but not actively controlled between T1 and T2.). Fluid injection was terminated well after the end of the electrical data acquisition, when seal failure was confirmed through the appearance of water on the surface of the block near the injection hole.

The flow chart used to process the electrical potential data is illustrated in FIG. 16. Block 1 illustrates the instrumentation on the porous block 1. Block 2 illustrates the data acquisition equipment. Block 3 illustrates the signal condition of the raw data. Block 4 illustrates the mapping voltage response using ordinary kriging. Block 5 illustrates the localization of the causative sources in the porous block 1.

### Electrical Potential Data

FIG. 17 illustrates the temporal evolution of the electrical potential for all of the electrodes 2, including the occurrence of bursts in the electrical potential that are similar in shape (but much larger in amplitude) to the electrical field bursts observed for Haines jumps during the drainage of an initially water-saturated sandbox. FIG. 17a illustrates the entire about 2086 s record, while FIG. 17b, FIG. 17c and FIG. 17d were expanded to illustrate specific areas of interest. There are seven major events of which three are highlighted (Events E1 through E3). Two were be used to test the localization procedure. These events are illustrated in the time series of FIG. 17b, FIG. 17c, and FIG. 17d. All major electrical potential events occurred during Phase II constant flow injection. During Phase I, the measured electrical potential gradually increased as fluid was injected into the porous block 1. No bursts in the electrical field were observed during the constant pressure phase (Phase I) and no burst in the acoustic emissions.

Each major event was characterized by a rapid change in the electrical potential time series followed by a slower exponential-type relaxation of the potential with a characteristic time comprised between several seconds to several tens of seconds. This relaxation was believed to be associated with the relaxation of the fluid pressure as illustrated later. Because the relaxation of the potential distribution was relatively slow after each event, a sequence of overlapping events causes a superposition of the potentials from each event in the sequence to varying degrees (see FIG. 17b and FIG. 17c). FIG. 17 illustrated that the degree of residual potential superposition was dependent on event physics (hydroelectric coupling), event magnitudes, event spatial distribution, time of occurrence, and event decay rate. Each of these factors was variable, and should be accounted for to localize and characterize individual impulsive events. The influence of residual potential superposition should be accounted for, and removed to complete a comprehensive analysis of the data.

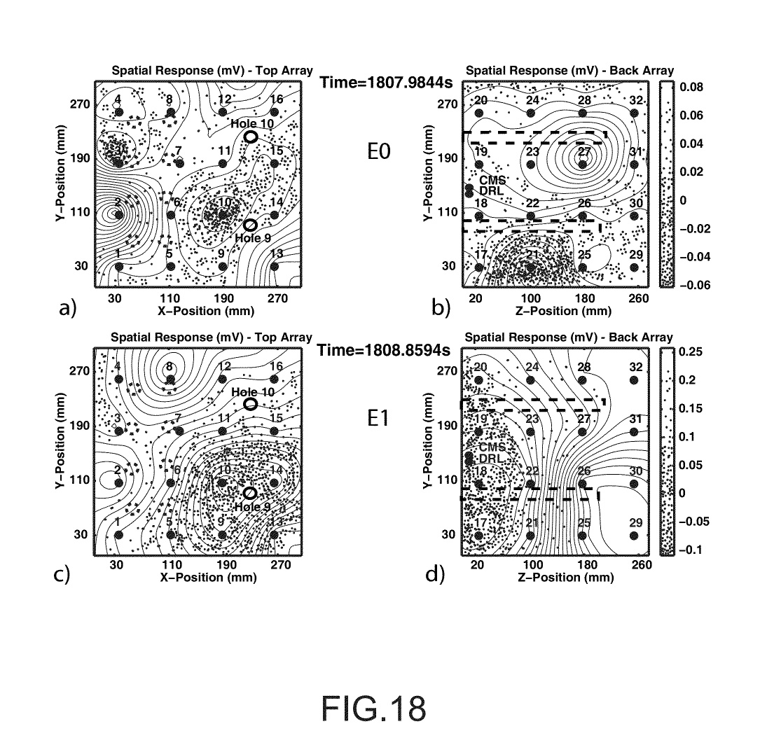

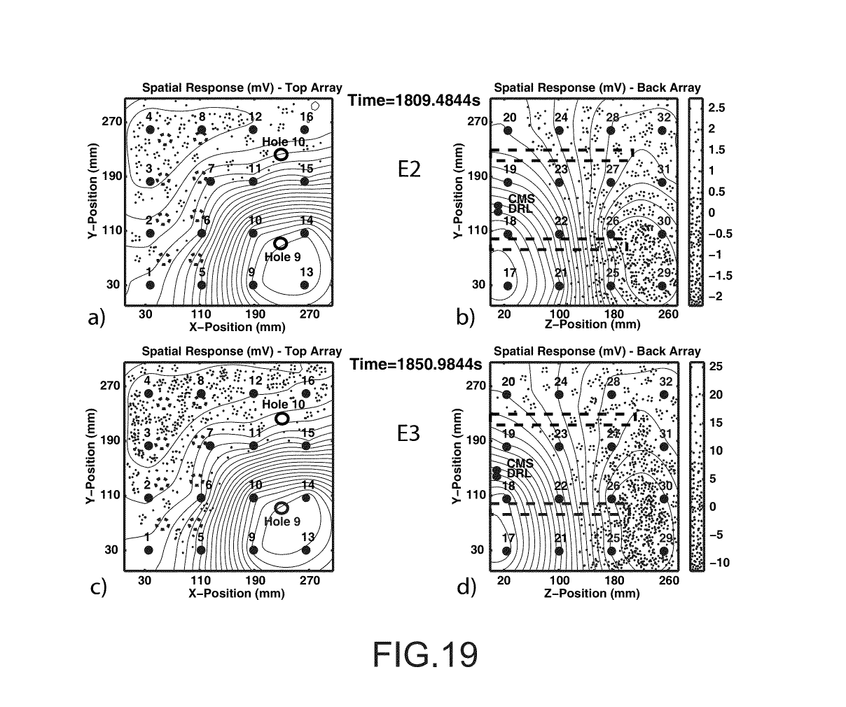

FIG. 18 and FIG. 19 illustrate the spatial evolution of the electrical potential on the monitored faces of the porous block 1. The dots denote the position of the electrodes 2. The dashed circles illustrate the position of the holes within the porous block 1. A snapshot, E0, was taken prior the occurrence of events E1 and E3. For these snapshots, ordinary spatial kriging was performed on each face separately. FIGS. 17d, FIG. 18a and FIG. 18b illustrate that the snapshot E0 illustrates random spatial electrical potential fluctuations associated with the temporal noise that can be seen in FIG. 17d. Channel 13 was noisier with respect to the rest of the channels possibly because of a poor contact between the electrode and the cement block.

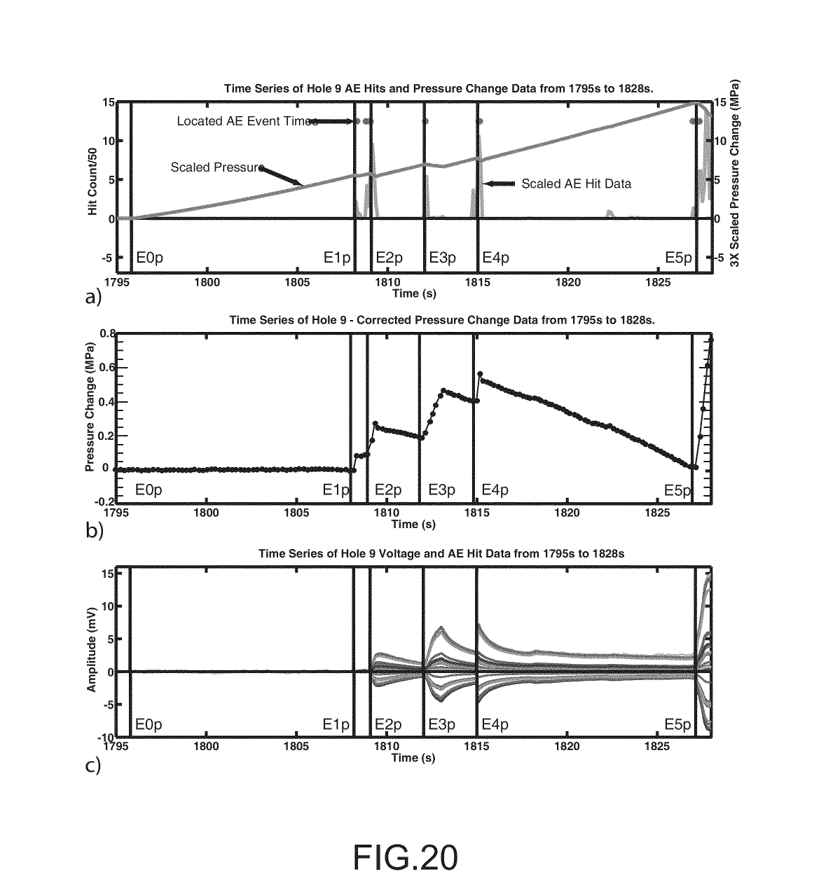

Event E1 in FIG. 18c and FIG. 18d illustrate an initial voltage distribution with a small negative potential on the top surface of the porous block 1 and a bipolar signal on the side of the porous block 1. This voltage distribution implies that there was a current source density possibly near hole 6 that was pointing mostly downward into the block. The time series in FIG. 17d illustrates the onset of this small peak (Event E1), followed by a quick decay and reversal of the polarity of the current source density as indicated by event E2 as illustrated in FIG. 17c and FIG. 19a and FIG. 19b. FIG. 19 illustrates the self-potential spatial voltage distributions of events E2 and E3. The polarity reversal may be described by a sequence of events. First, a brief pressure drop (E1p), seen in FIG. 20 just before the E1 peak, indicates some sort of pulse flow of fluid occurred, that may have led up to the E1 peak. The following reversal of polarity that peaks at E2 was correlated with another pressure drop, E2p, just prior to the peak at E2. This indicates that the initial fluid flow direction at E1 was in a downward direction, possibly an indication of the initial downward direction of a plastic failure in the epoxy seal before the reversal of flow direction due to other seal failures with higher volumes and mostly vertical flow directions. It is possible that the impulsive nature of these failures were unique to this particular epoxy seal technique that caused plastic seal failure. Additionally, gas pockets inside the epoxy interface with the hole wall may have explained the burst nature of the seal failure. This could have been caused by unequal distribution of the epoxy along the hole wall. The rupture of each gas pocket would produce a drop in pressure followed by an increase in the fluid flow along the hole wall, and, as a result, a self-potential response of electrokienetic nature. The direction of the current density corresponding to event E2 was mostly pointing upward and grew in magnitude in an impulsive manner as the fluid injection proceeds. The magnitude of the electrical potential grows from event E2 onward, and maintained the spatial voltage distribution/polarity throughout the remainder of the data acquisition. This implies that fluid was moving upward in a persistent manner, somewhere in the vicinity of hole 6 during and after event E2.

### Pressure and Acoustic Emission Data

FIG. 20 illustrates fluid pressure, acoustic emissions and electrical potential changes during a given time window. The change in the fluid pressure response (sampled at about 5 Hz) during constant flow injection (Phase II) was illustrated in FIG. 20. The acoustic emission hit counts in FIG. 20a. The acoustic emission hit counts peaked very close to and during the pressure changes. This indicates that some sort of breakage was occurring that resulted in a momentary pressure drop during these times and a release of the elastic energy stored in the system. The pressure and acoustic emission time series were highly temporally correlated. Breakages were followed by periods of low acoustic emission activity. The acoustic emission hit counts associated with event E1p peak at about 108 hits; the E2p counts peak at about 243 hits; the E3p event peaks at about 270 hits; finally the E4p hit count peaks at about 532 hits. The hit count corresponding to event E5p was more complex as characterized by three peaks. For the E5p event, there was a maximum acoustic emissions count above about 680 hits. The hits were based on exceeding an acoustic emission threshold level on each channel in the acoustic emission detection system. Only a few of the hits contained enough signal to noise ratio and channel to channel correlation without overlap to allow the localization of the acoustic emissions, especially in the region of hole 6 where a high number of sources of would be expected. If hits were localizable and localized, then they turn into acoustic emission events. FIG. 20a also illustrated the temporal correlation of the located acoustic emission events. FIG. 20b illustrated the trend removed pressure change data along with the event correlations. FIG. 20c illustrated the correlations between the voltage response and the pressure and acoustic emission changes.

FIG. 20 illustrates that the observed bursts in the electrical field are directly related to pressure changes that were measured in the injection system and acoustic emission hits. The pressure data indicated that there were some sharp changes in the flow regime inside hole 6 and the leakages were only occurring inside the block (the occurrence of electrical data illustrates that the fluid that moved was in contact with porous media; no electrokinetic phenomena would occur outside the block and directly in the stainless steel injection tube). The large number of temporally correlated acoustic emission hits indicated that something was breaking at the times of the pressure and voltage changes. The drops in pressure and correlated increase in voltage indicated that fluid was moving in the system. The drops in pressure indicate that the fluid flow rate through the seal failure was momentarily higher than the fluid flowing into the system. This higher fluid flow rate depletes the fluid volume and pressure in the fluid injection system until the pathway associated with the seal failure closes. Flat pressure response during seal failure may be expected if the seal failure were to achieve a state of equilibrium over a short period of time, and that the volume of flow into the system was equal to the volume of flow out of the system. This was not observed in the experiment, which was a highly dynamic hydromechanical system. If pressure measurements were the only observations of these events, then these fluctuations would not be directly attributed to a seal failure mechanism. However, the existence of electrical data illustrates that there was a mechanism other than induced block fracturing going on. The electrical data provides a different set of observations, in a fluid flow context, that reveal more about the events in progress than could be inferred from just the pressure measurements. The electrical data implies seal failure, and the pressure data confirms fluid movement. The electrical data actually provides more detail of the early development of the seal failure process, which can be used to localize these events indicating an imminent seal failure. Each of the pressure drops in illustrated in FIG. 20 indicated that the seal was progressively failing (not full failure for each event), resulting in the burst like behavior described in the previous section. Only when the pressure decreases precipitously (E5p in FIG. 20) could a full seal failure be identified from the pressure data. Further, the location of the failure within the hole could not be determined from pressure data alone. This combination of observations illustrates the strong correlation between mechanical effects and electrical responses, indicating the breakage of material along with the movement of fluid in the system. Each observation by itself is insufficient to explain the physical processes occurring within the block; however, the combination of the measurements strengthens the understanding of the physical changes within the block.

### Electrical Potential Evidence of Seal Failure

The persistent voltage distribution illustrated in FIG. 19 indicated the effects of upward fluid migration somewhere near hole 6, which is a leading indicator of the borehole seal failure. This seal failure was further confirmed through fluid pressure measurements and the leakage along the borehole was later visually confirmed through the observation of water flow at the top surface of the block in the vicinity of hole 6. The temporal electrical signatures in FIG. 17 illustrated numerous impulsive events that grow as the seal failure progresses. The seal failure occurred in the epoxy-filled annulus of the borehole between the steel tube and the cement; as more fluid contacted the cement walls of the borehole with higher and higher velocities, the magnitude of the electrical response grew accordingly. The approximate position of the fluid contacted with the borehole wall was determined from the data. The position of the positive anomaly recorded by the top array was not centered on hole 6, but is displaced, from the center of the hole, possibly because of the position of the electrodes and the electrical boundary conditions of hole 6.

The data from the side face electrical potential array also contained source location and orientation information, indicating that the fluid flow encountered porous media somewhere well above the bottom of the borehole, also a potential indication of borehole seal failure. The observations implied that the fluid flow occurred along a pathway following the borehole and close to the lower right corner of the top array. The electrical boundary conditions in the borehole were insulating between the borehole wall and the stainless steel tubing, causing the reflection of the electrical potential away from the borehole center. These electrical potential measurements were consistent with the subsequent observations of fluid leakage at the test block surface near hole 6 due to borehole seal failure. These electrical observations occurred several minutes before surface fluid leakage was visually observed on the top surface.

### Example 2

A simple, finite element numerical geophysical model of a well with a casing leak was developed using Comsol Multiphysics. This model was developed to understand what a leaking well looks like from a measurement perspective, in the far field, far from the well. The model was used to determine the magnitude of the streaming potential response under a specific pressure stimulation due to a leaking well at various distances, the spatial distribution of the voltage generated by a leak at a distance that produces measurable signals, and the effect of the casing (which intercepted some of the streaming current) on a voltage that influenced the spatial distribution of the voltage that could be measured by a subsurface sensor system. After observing the alteration in the voltage distribution, additional experiments focused on eliminating the casing potential disturbance to allow for the use of simpler source localization methods. The results of this model are described below.

### Model Geometry and Construction

A finite element based, steady state geophysical model was generated using a simple cubical block construction that incorporates several other features, including a simulated leaky well. The physics defined by the model couples electrical currents to porous and free fluid flow. The coupling of Ohms Law for electrical currents to Darcy's Law for fluid flow in porous media was applied to simulate the streaming potential response. This simulation was accomplished by using the electrical double layer model of porous media and the coupling between fluid velocity and the movement of ions from dissolved salts that are present in the water in the pore spaces of porous media. Pore water is not neutral because of the surface charge on the mineral grain surfaces that attract ions in the water toward the grain surfaces. The saline water produced an excess charge density close to the mineral grain surface. The movement of water near the surface of mineral grains dragged the ions constituting the excess charge density in the pore space, and produced an electrical current that was defined as the so called “streaming current.” This streaming current was balanced by an electrical conduction current that maintained charge neutrality throughout the system. We defined the porous media in terms of conductivity, porosity, water saturation, and permeability. From the porous media definitions, an empirically derived excess charge density formula relating excess charge density to porous media permeability was used. Additionally, the fluids within the pore space had a finite conductivity due to the salinity of the water, and through Archie's Law relating the conductivity of porous media to porosity and water saturation, the porous body had a finite conductivity or resistivity. Electrical current flowing through the porous media resistivity generated a voltage through the application of Ohm's Law. This voltage constituted the so called “streaming potential.” This voltage was modeled and would ultimately be measured in real conditions. The quasi steady state forms of the coupled differential equations were used to yield a steady state solution to the problem. This simulated the solution of the problem at a time where all transient solutions of the model have settled to final values. Essentially, this solved for time at infinity numerical solutions.

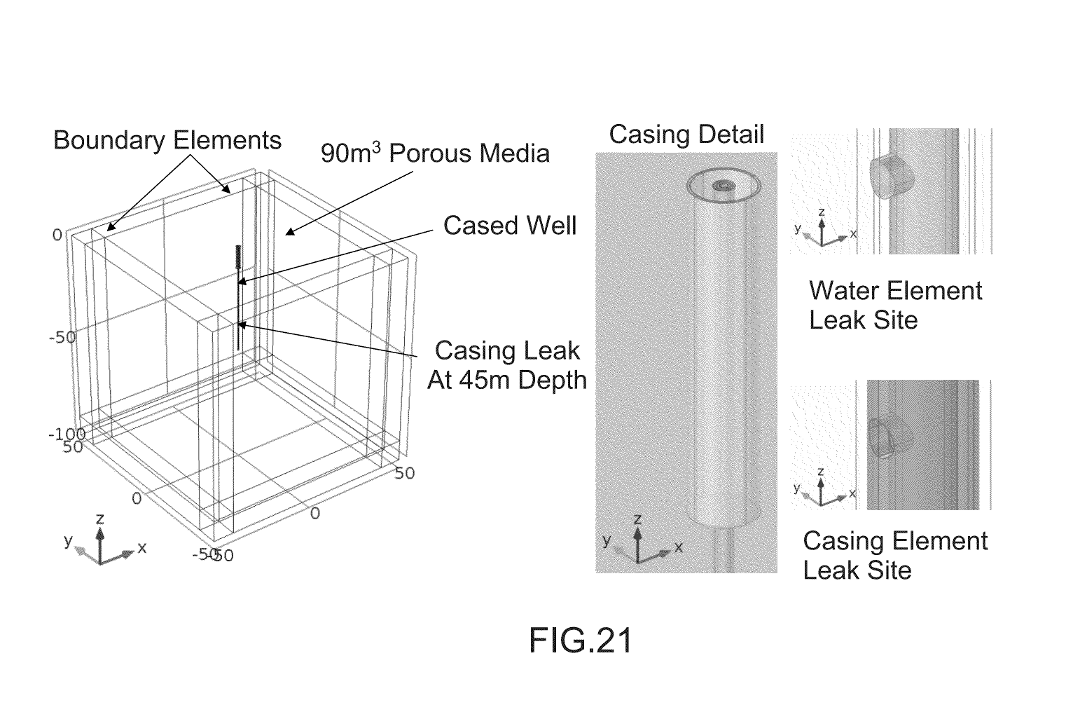

This model was constructed to represent a somewhat realistic subsurface volume of the earth that is reasonable for a monitoring system deployment, and still be tractable to compute in a reasonable period of time. The model represented a cubical volume of about 100 m×about 100 m×about 100 m, which was a reasonable volume, while still being representative of a real situation. Because of this volume limitation, the model has boundaries, and these boundaries must simulate the real life situation of an unbounded half space that was representative of the earth. These boundaries were required to have mathematical boundary conditions that enabled the solution of the sets of differential equations used to solve for the states of the model while still simulating the conditions inside the earth where the only limiting boundary was the surface of the earth (a half space). To simulate this condition, the boundary elements and outer surface conditions that simulated the “infinite” subsurface earth condition were defined. There are two boundary conditions that must be met to simulate the subsurface conditions of the real environment. First, all electrical currents in the system should have ground at “infinity,” and the fluid velocity vector at the boundary should simulate the passage of fluid through it as though the boundary was not there. These two conditions may be met in somewhat different ways. For electrical currents, a 10 m zone around the subsurface portion of the model was constructed as an infinite element that grades the electrical current based solutions of the model equations through the volumes of those elements in a way that caused the currents and voltages to achieve the ground state or zero volts at the outer boundary of the model (the outside of the boundary elements) without altering the solutions and vector relationships outside of the 10 m boundary element (the inner portion of the model). For the fluid flow part of the model, the outer boundary of the model was defined as a free flowing surface. This boundary condition allowed the simulation of fluid flow at the boundary as if the fluid passed through the boundary as though it was not there. This boundary condition also preserved the vector relationships of the fluid flow at the outer boundary of the model. In general, these techniques generated a 10 m zone around the model perimeter where the model solutions were of no interest, but were necessary for proper model functioning. FIG. 21 illustrates key details of the model construction.

The well was constructed using metallic casings, concrete annulus, and water elements. The metallic elements were a 10 m long conductor casing with a 60 m surface casing in the middle. The surface casing was surrounded by a cement annulus. A hole in the surface casing was located at a depth of 45 m that connected the water in the casing with the cement annulus. Pressure was applied to the top of the water element inside the casing. The casing was defined to have an extremely low porosity, such that the fluid flow through the hole in the casing dominated the model response.

### Model Results

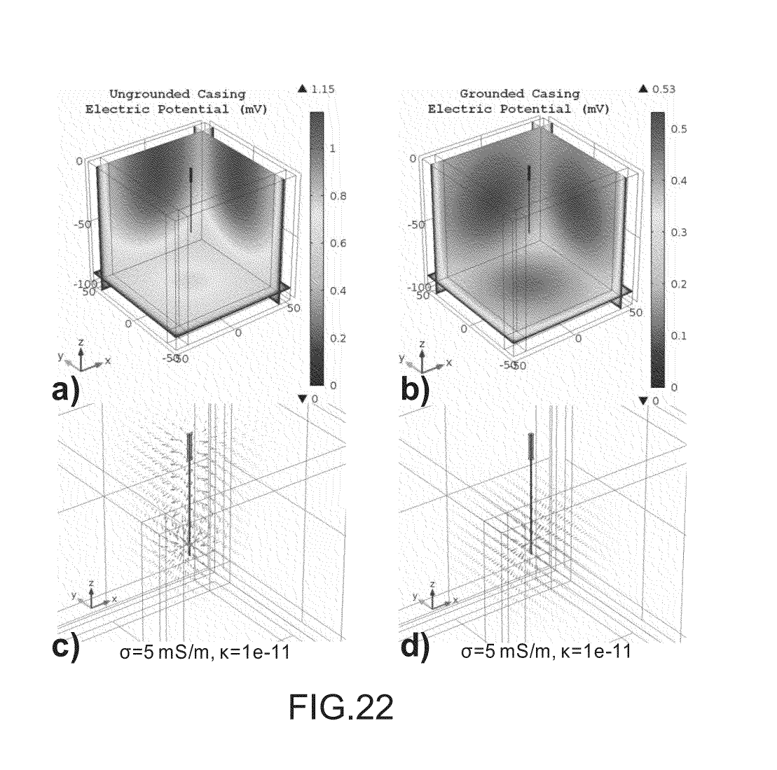

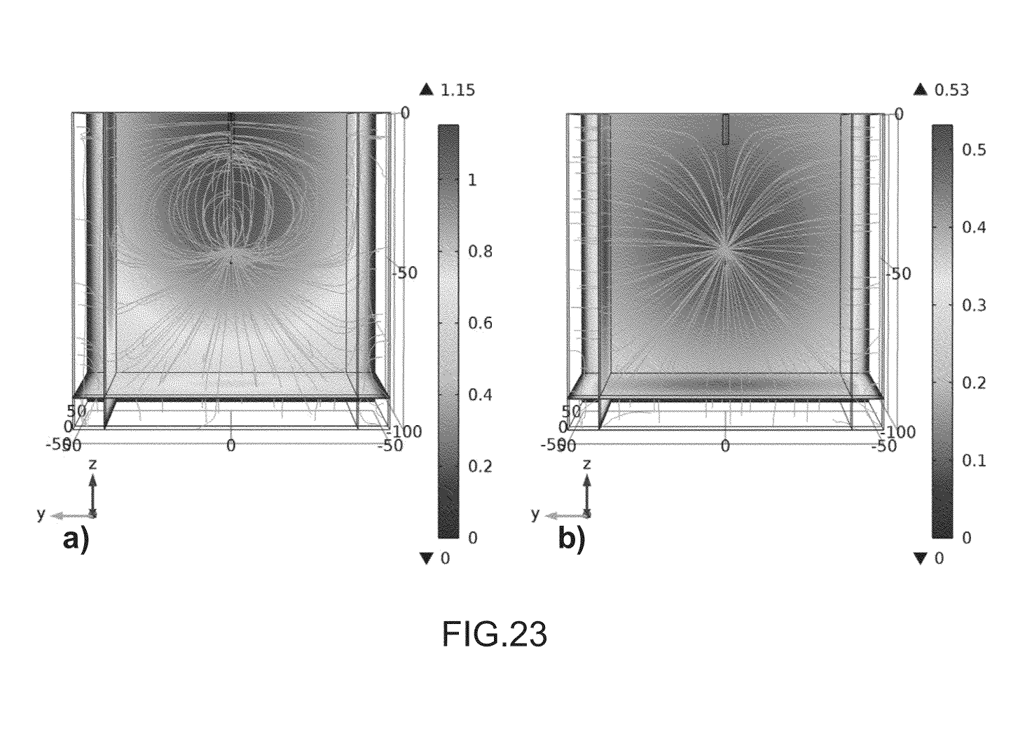

The steady state solutions of the model presented for two of the several cases that were evaluated are illustrated in FIGS. 22 and 23. In both of these cases, the porous media dominating factors were water saturation, conductivity, and permeability, and were 100%, about 5×10⁻³ S/m and about 1×10⁻¹¹ m² respectively. About 1 psi (approximately 6894.757 Pa) pressure was applied to the top of the water element inside the casing of the well (a very small pressure for a well system). This forced water out of the hole in the casing through the cement annulus and into the modeled formation. FIGS. 22 and 23 illustrate the voltage response at a distance of about 40 m from the center of the model, where the well was. Additionally, FIGS. 22c and 22d illustrate the streaming current in the porous volume using a vector display of cones that point in the direction of current flow. The purple lines in FIG. 23 illustrate the streaming current flow lines. The current lines refocus on the casings in FIGS. 22c and 23a, and some of the current that flowed through the casing, caused a voltage to appear on the casing. This casing potential caused a voltage gradient that radiated from the casing into the porous media volume. This casing related potential added in superposition with the streaming potential generated by the movement of fluid within the porous media, and resulted in a voltage that has a potential that is near about 1 mV at its maximum. FIGS. 22b and 23b illustrate the potential distribution when the casing potential was grounded or was at zero volts. It should be noted in FIGS. 22d and 23b, after the casing was forced to zero volts, that the electrical current did not flow through the casing, but instead flowed through the porous media bulk, and through the infinite boundary element toward the model boundary where the potential was zero volts or electrical ground. The resulting voltage distribution and current lines represented only the streaming potential and the streaming current respectively.

Analysis of these results demonstrated that well casing leakage may generate a voltage within a porous media volume. The voltage distributions in both evaluated cases had features that were unique to a well leakage signature. Additionally, the spatial voltage distribution indicated leakage location information that may be extracted from measurements using a properly configured data acquisition system. Also, a well leakage may shunt some of the streaming current into the metallic casing of a well. This current may generate a voltage on the casing. This casing voltage may also have a surface expression that could be measured with an appropriately configured data acquisition system.

The model illustrated that useful electrical signals may be generated from a leaking well, and that the spatial voltage distribution caused by a leak may be useful for locating the position of the leak within a well. It is also clear that it may be possible to detect well leakages anywhere in the subsurface portion of a well using the voltage that was expressed on and around a well casing. A surface based measurement and monitoring system may be able to exploit the casing based signature present during leakage events. However, when using a surface based leak detection method that exploits the casing potential, leak position may not be determinable.

While various embodiments have been described in detail, it is apparent that modifications and alterations of those embodiments will occur to those skilled in the art. For example, in the foregoing description of the invention, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions, to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software. It is to be expressly understood that such modifications and alterations are within the scope and spirit of the claimed invention, as set forth in the following claims.

What is claimed is:

1. A method for monitoring an aquifer proximate to a potentially contaminating operation, the method comprising:
drilling at least one monitoring wells;
positioning at least one sensor in the at least one monitoring wells;
acquiring measurements with the at least one sensor; and
analyzing the measurements for disturbance signals.

2. The method of claim 1, wherein the at least one sensor is selected from the group consisting of at least one pressure sensor, at least one temperature sensor, at least one chemical sensor, at least one vector magnetometer, at least one electric potential sensor employing at least one non-polarizing electrode, at least one electric potential sensor employing at least one metallic electrode, at least one electric potential sensor employing at least one non-polarizing electrode and at least one polarizing electrode and combinations thereof.

3. The method of claim 2, wherein the at least one sensor is the at least one electric potential sensor employing the at least one metallic electrode.

4. The method of claim 2, wherein the at least one sensor is the at least one non-polarizing electrode.

5. The method of claim 2, wherein the at least one sensor is the at least one electric potential sensor employing the at least one non-polarizing electrode and the at least one polarizing electrode.

6. The method of claim 1, further comprising a timing synchronizer, wherein the timing synchronizer minimizing differences between measurements of the at least one sensor.

7. The method of claim 1, further comprising at least one preamplifier to amplify the signal from the at least one sensor.

8. The method of claim 2, wherein the at least one sensor is the at least one temperature sensor for correcting the measurements.

9. The method of claim 1, further comprising measuring the telluric effects; and accounting for the telluric effects when analyzing the measurements.

10. The method of claim 1, wherein the measurements are analog measurements, wherein the method further comprises converting the analog measurements to a digital measurement.

11. A system for monitoring an aquifer proximate to a potentially contaminating operation, the system comprising:
at least one monitoring well positioned in proximity to at least one monitored well;
at least one sensor in the at least one monitoring well;
a data acquisition system for receiving information from the at least one sensor; and
a processing system for processing the information.

12. The system of claim 11, further comprising at least one device, and at least one device preamplifier.

13. The method of claim 12, wherein the at least one device is selected from the group consisting of a vector magnetometer, geophone, a hydrophone, an accelerometer and combinations thereof.

14. The system of claim 11, wherein the at least one sensor is selected from the group consisting of at least one pressure sensor, at least one temperature sensor, at least one chemical sensor, at least one vector magnetometer, at least one electric potential sensor employing at least one non-polarizing electrode, at least one electric potential sensor employing at least one metallic electrode, at least one electric potential sensor employing at least one non-polarizing electrode and at least one polarizing electrode and combinations thereof.

15. The system of claim 11, further comprising a timing synchronizer to minimize differences between measurements of the at least one sensor.

16. The system of claim 11, further comprising a magnetotelluric monitoring system, the magnetotelluric monitoring system comprising:
a communication interface;
a signal digitizer;
a timing synchronizer;
a controller;
a coil interface;
an electrode interface;
at least one non-polarizing electrodes, wherein the at least one non-polarizing electrodes communicates with the electrode interface; and
at least one temperature sensor.

17. The system of claim 11, further comprising at least one induction based sensor coil, wherein the at least one induction based sensor coil interfaces with the coil interface.

18. The system claim 11, wherein the at least one sensor outputs analog measurements, further comprising a converter for converting the analog measurements to the digital measurement.

19. A method for monitoring an abandoned well for a potential leak, the method comprising:
collecting measurements near the abandoned well at a surface of the abandoned well;
generating a differential spacial distribution streaming potential distribution with the measurements;
generating spatial changes in resistivity within a zone relatively near the abandoned well with the measurements; and
analyzing the spatial distribution streaming potential distribution and the spatial changes in resistivity to determine if the abandoned well is leaking.

20. The method of claim 19, further comprising:
repeating the collecting measurements after the abandoned well is repaired to determine if a leak still exists.
